(19) United States
(12) Patent Application Publication
(10) Pub. No.: US 2011/0047540 A1
(43) Pub. Date: Feb. 24, 2011

(54) System and Methodology for Automating Delivery, Licensing, and Availability of Software Products

(75) Inventors: Wayne D. Williams, Monterey, CA (US); Michael L. Swindell, Aptos, CA (US); James B. Pitts, Toronto (CA)

Correspondence Address: JOHN A. SMART, 201 LOS GATOS, SARATOGA RD, #161, LOS GATOS, CA, 95030-5308, US

(73) Assignee: EMBARCADERO TECHNOLOGIES INC., San Francisco, CA (US)

(21) Appl. No.: 12/695,130

(22) Filed: Jan. 27, 2010

Related U.S. Application Data
(60) Provisional application No. 61/236,505, filed on Aug. 24, 2009.
(60) Provisional application No. 61/295,700, filed on Jan. 16, 2010.

(51) Int. Cl. G06F 3/01; G06F 9/445; G06F 3/048

(52) U.S. Cl. 717/178; 715/740; 715/810

(57) ABSTRACT

System and methodology automating delivery, licensing, and availability of software products are shown and described. In one embodiment, for example, a system of the present invention for delivering and licensing application software is described that comprises: a cloud server storing a plurality of software applications, including storing metadata indicating permitted licensing and operation of the software applications; a client computer for operating software applications, the client computer in communication with the cloud server; a client user interface at the client computer, which allows a user to request software applications from the cloud server; a communication module at the cloud server, for receiving requests from the user to operate particular software applications at the client computer; an authentication module at the cloud server, for authenticating the requests received from the user to operate certain software applications at the client computer; and a local library at the client computer for receiving from the cloud server the particular software applications requested by the user and making those applications available for operation at the client computer, pursuant to permitted licensing and operation specified by the metadata.

### CROSS REFERENCE TO RELATED APPLICATIONS

The present application is related to and claims the benefit of priority of the following commonly-owned, presently-pending provisional application(s): application Ser. No. 61/236,505 (Docket No. ETI/0002.00), filed Aug. 24, 2009, entitled “System and Methodology Providing Lifecycle Management of Software Products”, of which the present application is a non-provisional application thereof; application Ser. No. 61/295,700 (Docket No. ETI/0002.01), filed Jan. 16, 2010, entitled “System and Methodology Providing Lifecycle Management of Software Products”, of which the present application is a non-provisional application thereof. The disclosures of each of the foregoing applications are hereby incorporated by reference in their entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e): This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, size: 208347 Bytes, created: Jan. 25, 2010 5:53:46 PM; Object ID: File No. 1; Object Contents: Source code.

### BACKGROUND OF INVENTION

1. Field of the Invention

The present invention relates generally to data processing and computing environments and, more particularly, to system and methods for automating the delivery, licensing, and availability of application software.

2. Description of the Background Art

Today, online purchase and distribution of software is commonplace. This can be viewed in terms of a purchase-to-usage “chain” that includes different participants: vendors (i.e., ISVs—independent software vendors), purchasers, administrators, and users (e.g., “end users”). The purchase of a particular software package, for example, can be viewed as a process that flows down the chain, from the vendor all the way down to the ultimate end user. The purchase and deployment of software is not a simple linear process, however, but instead includes a number of cycles that occur on an ongoing basis, including installation, provisioning/configuration, updates/bug fixes, and new products purchases, to name a few. The overall process is made more difficult by PC instability; as more software is installed, a typical PC (personal computer) becomes less stable to operate. If a firm's purchase and use of software were confined to a single product from a single vendor, these ongoing cycles would be more or less manageable by the firm (e.g., corporate IT department). Of course purchasers of software, particularly corporate purchasers, are not confined to using a single software product or even a single vendor. Instead, the norm is to purchase and deploy multiple software packages from multiple vendors, and for each software product one may have purchased and deployed multiple versions. The typical firm must manage hundreds of different combinations of vendors and packages (and often different versions and/or configurations thereof).

This scenario is problematic for software customers, particularly large corporations which must manage an ever-increasing morass of different licensing schemes. Not only must a firm track the licenses for software that it has purchased (e.g., what users go with which licenses, and for which products), but the firm must also contend with disparate licensing schemes; licensing terms are not consistent from one product to another, let alone from one vendor to another. The problem has become increasingly unmanageable and the proliferation of product and devices to run those products continues unabated. Many software customers today are finding that the main cost for software is not its purchase price but the costs of all the management tasks (e.g., installation, provisioning, configuring, updating, license tracking, and so forth) associated with the software. The problem is not confined just to corporate IT departments and their administrators, but extends all the way down to end users who must also contend with a number of issues: how to get a software product on one's machine, how to get updates, how to get new or different product, and so forth and so on.

To date, there have been attempts to solve various pieces of the problem. For example, license management software exists to help a firm track and manage software licenses that it has purchased. Similarly, solutions exist that attempt to automate the management of software configurations. Other solutions exist to automate provisioning of software. Although each of these solutions addresses a particular issue, each solution operates independently and is poorly integrated with the other. For example, license management software is not well integrated with configuration software, and neither is well integrated with provisioning software. Thus, organizations still do not have a solution that manages software all the way from its purchase, to installation, to its ultimate use on the user's desktop computer. The acquisition, management, and use of multiple software products from a single or multiple vendors is a difficult problem facing many firms today, and thus a better solution is sought.

### SUMMARY OF INVENTION

System and methodology automating delivery, licensing, and availability of software products are shown and described. In one embodiment, for example, a system of the present invention for delivering and licensing application software is described that comprises: a cloud server storing a plurality of software applications, including storing metadata indicating permitted licensing and operation of the software applications; a client computer for operating software applications, the client computer in communication with the cloud server; a client user interface at the client computer, which allows a user to request software applications from the cloud server; a communication module at the cloud server, for receiving requests from the user to operate particular software applications at the client computer; an authentication module at the cloud server, for authenticating the requests received from the user to operate certain software applications at the client computer; and a local library at the client computer for receiving from the cloud server the particular software applications requested by the user and making those applications available for operation at the client computer, pursuant to permitted licensing and operation specified by the metadata.

### BRIEF DESCRIPTION OF DRAWINGS

FIG. 1 is a very general block diagram of a computer system (e.g., an IBM-compatible system) in which software-implemented processes of the present invention may be embodied.

FIG. 2A is a block diagram illustrating the basic components that comprise the end-to-end lifecycle management system of the present invention.

FIG. 2B is a block diagram illustrating configuration of the system of FIG. 2A to support both public (e.g., Internet-based) and private (e.g., LAN-based) environments.

FIG. 2C is a block diagram illustrating the host server presented in FIG. 2B in further detail.

FIG. 3A is a bitmap screenshot illustrating the currently preferred user interface for the ToolBox (i.e., UI for the user client portion of the system).

FIG. 3B is a bitmap screenshot illustrating selection of a “Marketplace” within a “Store” hosted by the ToolBox.

FIG. 3C is a bitmap screenshot illustrating a report workspace provided by the system for real-time license tracking and usage reports.

FIG. 4 is a high-level flow diagram illustrating a method of the present invention for procuring applications, for example by purchasing applications from the public cloud (“Marketplace”).

FIGS. 5A-C comprise a detailed flow diagram illustrating a method of the present invention for automating the delivery, licensing, and availability of application software.

FIG. 6 is a detailed flow diagram illustrating a method of the present invention for converting an existing install file (e.g., Microsoft Windows Installer .MSI install file) into an instant-on application that runs with appropriate file and registry settings, as well as protected (virtual) file and registry settings.

FIG. 7 is a detailed flow diagram illustrating a method for building a Tool Cloud Application (TCA) and uploading or publishing it to a local tool cloud or public tool cloud (“Marketplace”).

### DETAILED DESCRIPTION

Glossary

The following definitions are offered for purposes of illustration, not limitation, in order to assist with understanding the discussion that follows.

LDAP (Lightweight Directory Access Protocol): A well known application protocol for querying and modifying directory services running over TCP/IP. The protocol is detailed in RFC 4510 (the disclosure of which is hereby incorporated by reference) and is available from Internet Engineering Task Force at ietf.org).

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

Package: Refers to a collection comprising one or more software modules, including binary executables (e.g., .exe files, under Microsoft Windows) was well as Java packages (e.g., .jar files), C# packages (e.g., files from .NET framework), and the like.

Relational database: A relational database is a collection of data items organized as a set of formally-described tables from which data can be accessed or reassembled in many different ways without having to reorganize the database tables. The relational database was invented by E. F. Codd at IBM in 1970. A relational database employs a set of tables containing data fitted into predefined categories. Each table (which is sometimes called a relation) contains one or more data categories in columns. A feature of a relational database is that users may define relationships between the tables in order to link data that is contained in multiple tables. The standard user and application program interface to a relational database is the Structured Query Language (SQL).

System Administrator: The System Administrator (SA) or simply “administrator” handles tasks that are not specific to applications and works outside the database system's discretionary access control system. System Administrator tasks include: Managing disk storage; Monitoring the database system's automatic recovery procedure; Fine-tuning the database system by changing configurable system parameters; Diagnosing and reporting system problems; Backing up and loading databases; Granting and revoking the System Administrator role; Modifying and dropping server login accounts; Granting permissions to database system users; Creating user databases and granting ownership of them; and Setting up groups which can be used for granting and revoking permissions.

TCP: TCP stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see e.g., “RFC 793: Transmission Control Program DARPA Internet Program Protocol Specification”, the disclosure of which is hereby incorporated by reference. A copy of RFC 793 is available via the Internet (e.g., currently at www.ietf.org/rfc/rfc793.txt).

TCP/IP: TCP/IP stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., “RFC 1180: A TCP/IP Tutorial”, the disclosure of which is hereby incorporated by reference. A copy of RFC 1180 is available via the Internet (e.g., currently at www.ietf.org/rfc/rfc1180.txt).

### Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh®, Linux®, Solaris®, UNIX®, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

### Computer-Based Implementation

Basic System Hardware and Software (e.g., For Desktop and Server Computers)

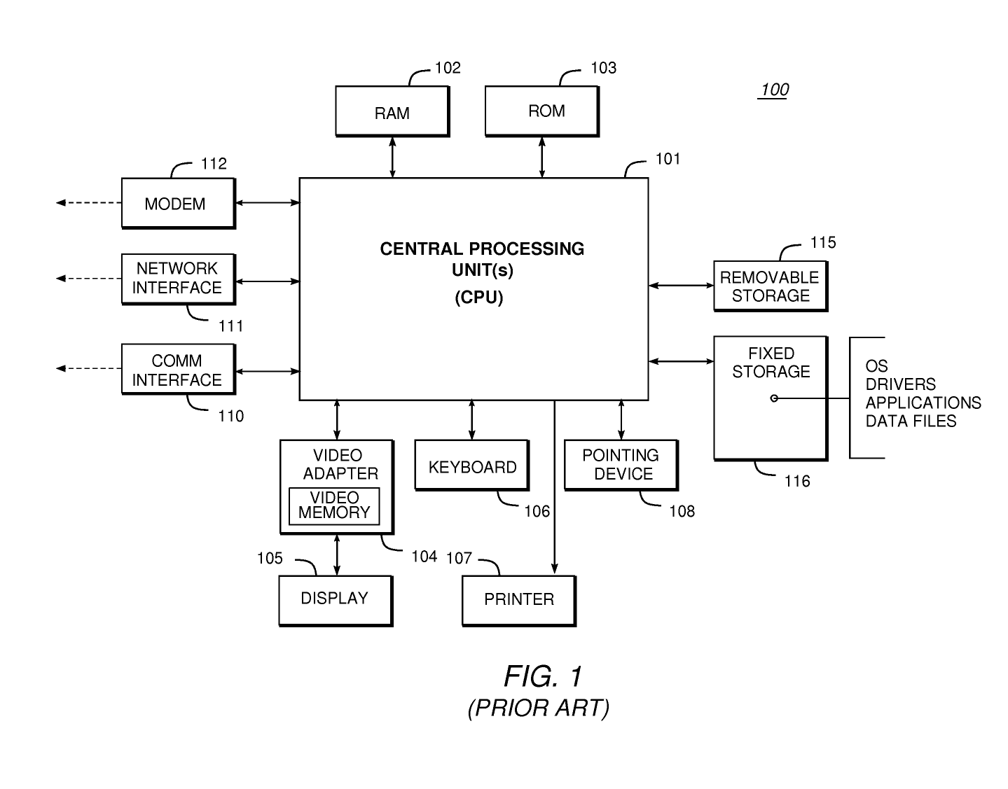

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of one gigabyte or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP LaserJet® printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft® Windows NT, Microsoft® Windows 2000, Microsoft® Windows XP, Microsoft® Windows Vista, or Microsoft® Windows 7 (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying computer components that may be employed for implementing the present invention. For purposes of discussion, the following description will present examples in which it will be assumed that there exists a “server” (e.g., primary server providing core services) that communicates with one or more “client” (e.g., a “user client” operating from a desktop computers). The present invention, however, is not limited to any particular environment or device configuration. In particular, a client/server-based distinction is not necessary to the invention, but is used to provide a framework for discussion. Instead, the present invention may be implemented in any type of system architecture or processing environment capable of supporting the methodologies of the present invention presented in detail below.

### End-to-End Lifecycle Management of Software Acquisition, Deployment, and Use

Overview

In accordance with the present invention, an end-to-end system (commercially embodied as in All-Access™ and ToolCloud™ products/services) is provided for automating the delivery, licensing, and availability of application software. The system represents the first solution that ties all of these actions together into a single system, which extends all the way from the vendor, to the administrator, and then to the user, all in a fluid delivery cycle that operates on demand. At its core, the system is implemented as a set of services that facilitate delivery, licensing, and availability of software, and also supports on-demand virtualization of software with automated license activation (as described in further detail below).

In the currently preferred embodiment, the system employs client/server architecture. A “user client” module or “ToolBox” is installed at each user's machine and provides a console or “dashboard” that communicates with a host cloud server (ToolCloud™ server), thus forming a closed loop system within which the entire lifecycle is managed. For example, when a new software package is available, the client (user) immediately sees it as the server alerts the client. In a similar fashion, when an update is available, it is immediately available to the client (which can then proceed to download the update in the background). Thus in this manner, a multitude of software packages may be placed on the server and be made immediately available to the client. The client in turn may download and install any of the available software packages, or alternatively execute software packages using on-demand virtualization with automated license activation.

System Components

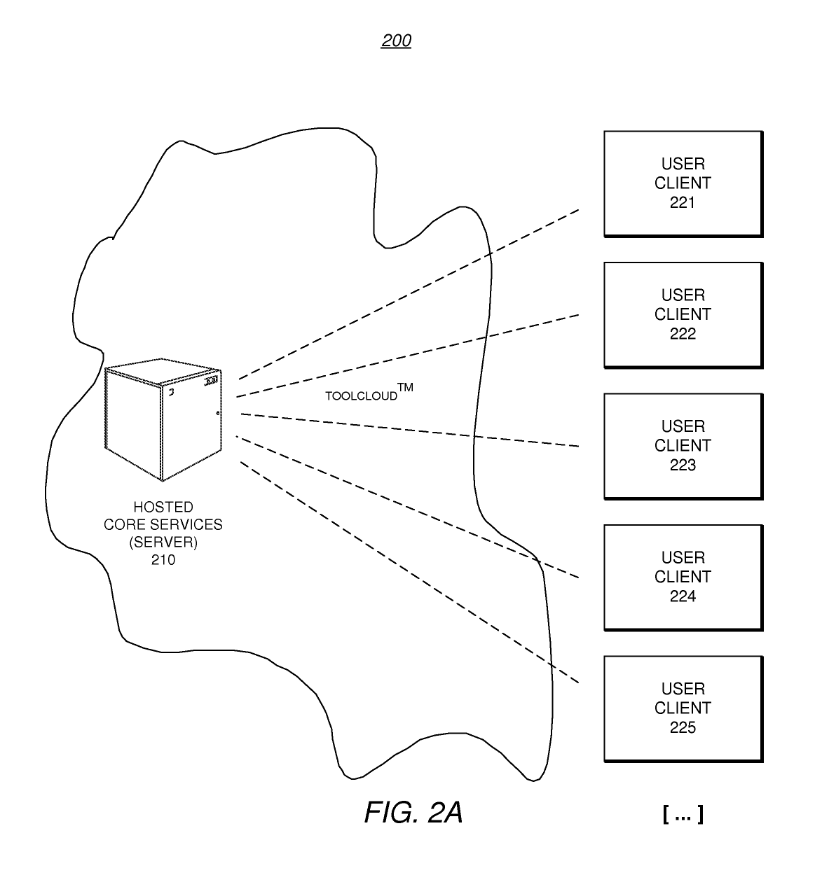

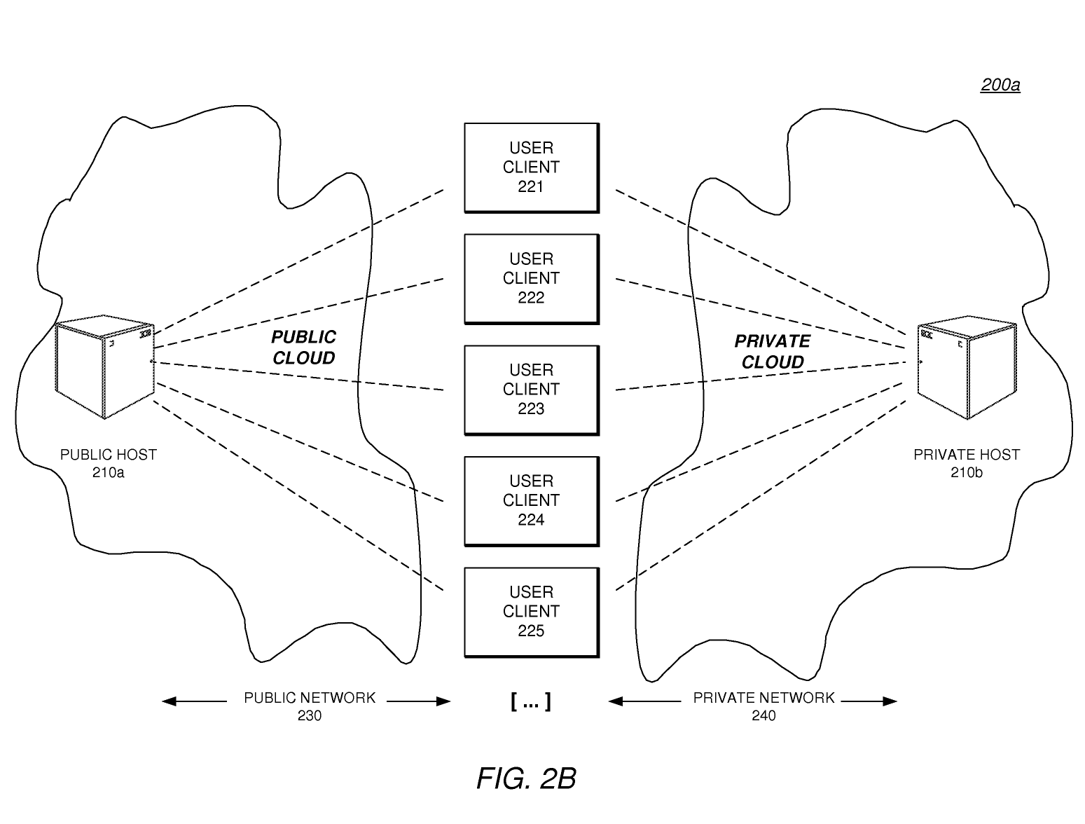

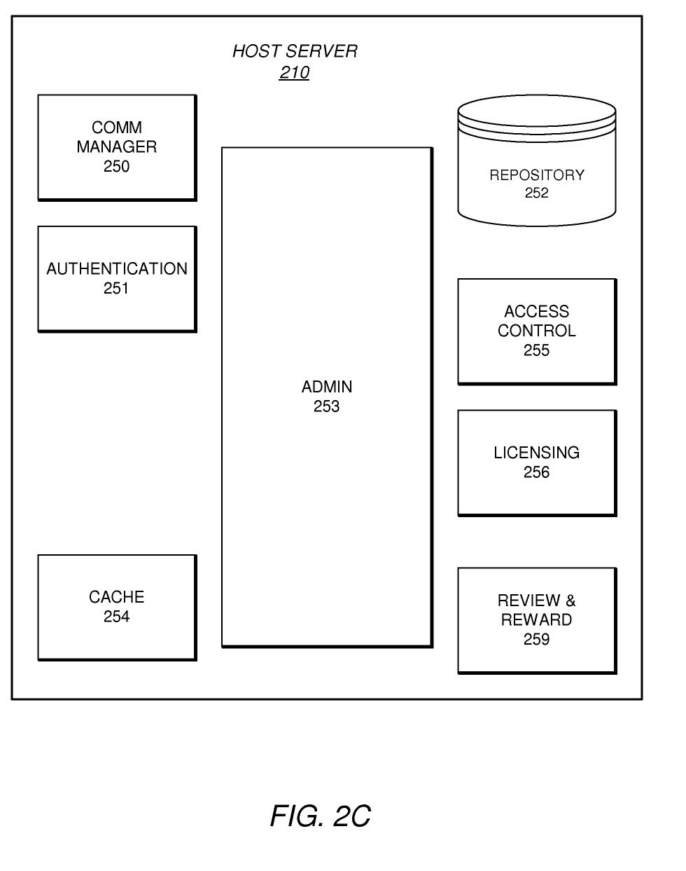

FIG. 2A is a block diagram illustrating the basic components that comprise the ToolCloud™ software lifecycle management system of the present invention. As shown, system 200 includes a plurality of user clients (ToolBoxes), such as user clients 221-225, that connect to a host system (“cloud server”) 210 which provides a ToolCloud™ (i.e., cloud server hosted) environment. Each user client connects to the host system 210 on a one-to-one basis; for example, user client 221 connects to host system 210 on a one-to-one basis for managing the specific software package(s) that user client 221 has licensed, including downloading, installing, licensing, running, and maintaining specific software on a one-to-one basis.

The ToolCloud™ environment itself may be run with both public and private cloud components. FIG. 2B illustrates the system 200 (now 200a) configured in this manner. The public environment represents a publicly-accessible solution available via a public network. As shown, system 200a includes the plurality of user clients 221-225 connecting to a public cloud, that is, connecting to a host system (server) 210a via a public network 230, such as the Internet. Additionally, the user clients 221-225 connect to a private cloud, specifically, the private host system (server) 210b accessible via a private network 240, such as a corporate LAN (local area network). Although the figure illustrates a simplified embodiment having two clouds (i.e., one public and one private), the present invention is not limited in this fashion; instead, a plurality of clouds may be supported. In a typical deployment, the system will include one public cloud and multiple private clouds.

Each private cloud represents a local server deployment inside an organization, for example, placing the host server 210 on site (e.g., as private host 210b), with local administration, for servicing internal clients. In this manner, each private cloud is well-positioned to furnish a firm's users with managed access to all the software that the firm has licensed. Each private cloud includes an application cache that is loaded from media and/or other clouds. Typically, a given private cloud pulls applications into its application cache from the public cloud (e.g., via HTTP communication protocol), thereby allowing the private cloud to offer an up-to-date catalog of applications.

FIG. 2C is a block diagram illustrating the host server 210 in further detail. As shown, the server 210 includes the following modules: a communication (comm) manager or module 250, authentication module 251, repository 252, administration (admin)/configuration module 253, cache module 254, access control manager or module 255, licensing module 256, and review and reward module 259. Each of these will be described in further detail.

The communication manager 250 engages in communication with clients and other servers, via communication traffic on one or more preconfigured ports. The communications manager 250 works in conjunction with the authentication module 251, which authenticates clients wishing to connect to the host server 210. Repository 252 is used as a storage mechanism to store persistent data, including software product information such as versions, updates, configurations, and licensing information. In the currently preferred embodiment, the repository 252 is implemented using an embedded SQL relational database.

The cache module 254 is a file-based storage for caching products locally (i.e., increases speed of retrieval) and includes versioning features for tracking disparate copies of each product cached. Each software product is made available via a network share that authorized ToolBoxes can access. From the network share, a given ToolBox may launch an application directly (if the application is set up for instant-on access, described below) or copy (download) the application to the ToolBox's local library. Each software product can have multiple versions, and each version in turn can have multiple possible configurations. Thus, each “flavor” (i.e., specific version and specific configuration) of a product can have its own unique “binary” (i.e., binary image on disk). The cache module 254 keeps track of these different binaries.

Access to individual products (i.e., what products are made available to a given ToolBox) is controlled by the access control manager 255. User credentials are automatically resolved against available licenses. The particular licensing terms that a given product is available under is tracked by the licensing module 256. The module provides a means by which each cloud server can marshal out licensing terms to individual clients (ToolBoxes) and captures usage statistics based on the licensing. This can be done automatically and transparently, thus freeing individual users from the task of license management. Review and reward module 259 captures user reviews of products. The module includes a reward component to give recognition to users under appropriate circumstances, such as rewarding users who provide reviews or upload useful configurations.

Overall administration of the system 210 is controlled via administration (admin)/configuration module 253. The module includes a user interface allowing the system administrator to specify configurations, including a permission model that establishes access rights for users. The administrator can create different client (ToolBox) configurations and assign each to a particular group of users. Additionally, the administrator uses the interface to load the various software products that will be offered by the system, and enter relevant licensing information for each such product.

“ToolBox” User Interface (UI) Walk-Through

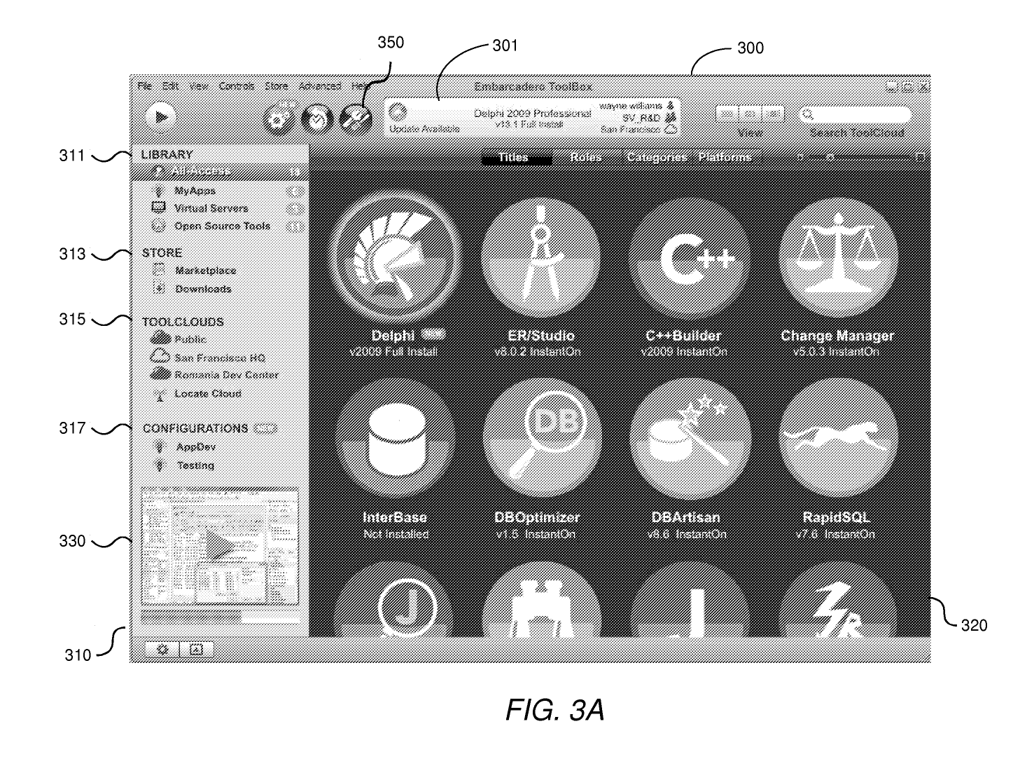

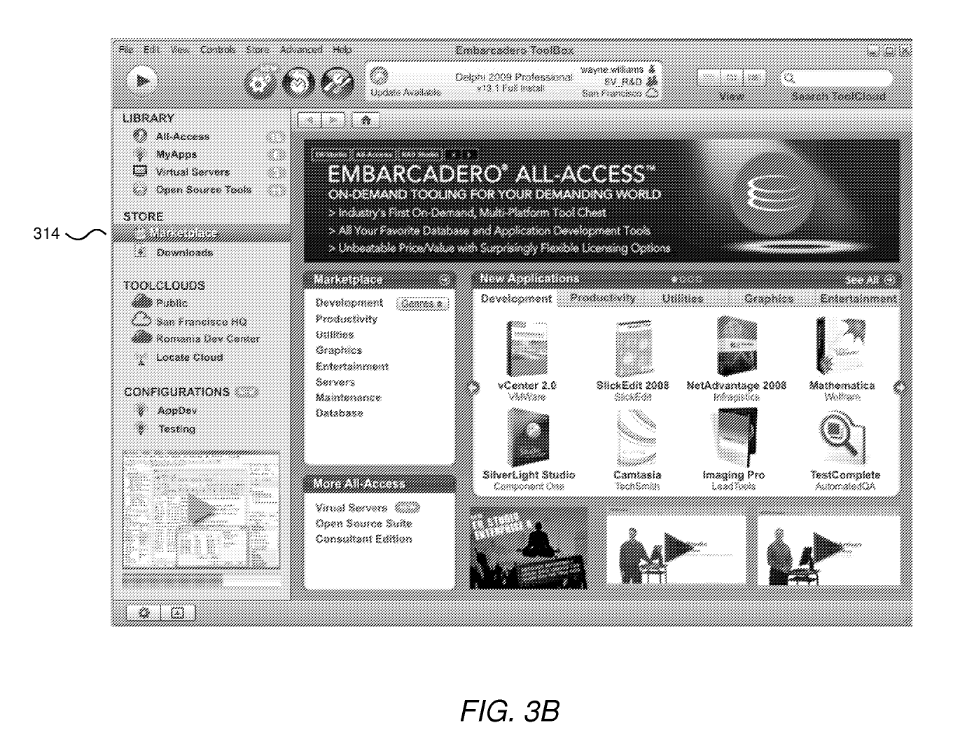

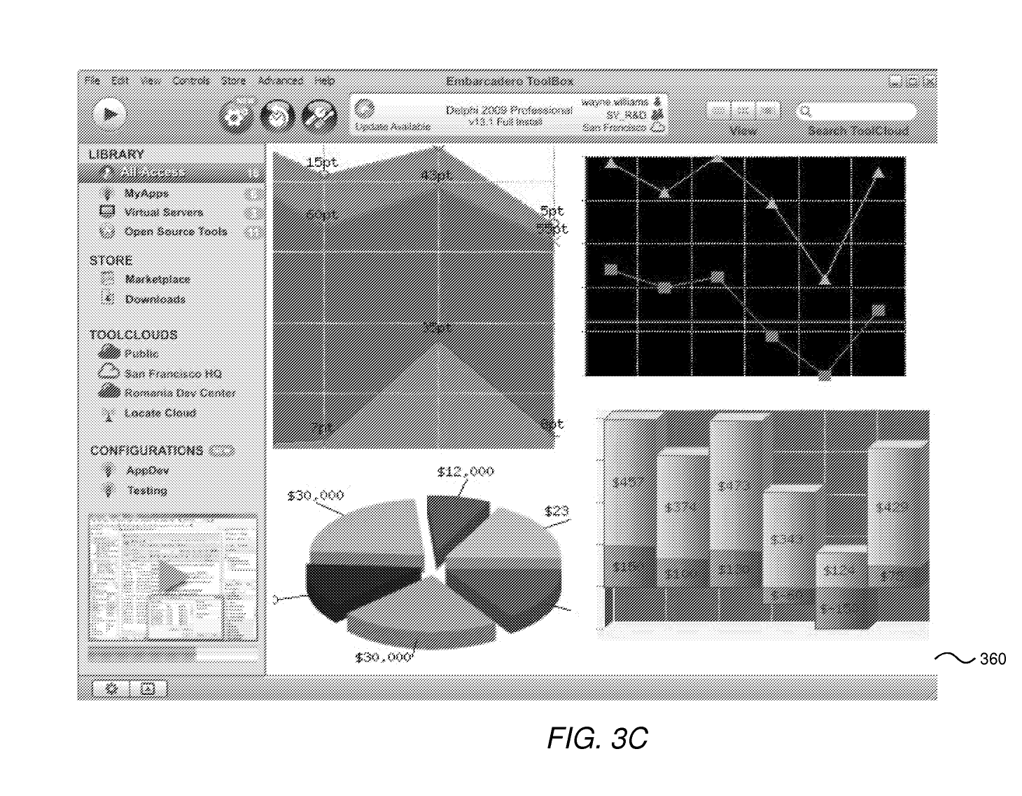

FIG. 3A is a bitmap screenshot illustrating the currently preferred user interface 300 for the “ToolBox,” which serves as the UI for the user client. The typical usage case for a given user is as follows. Upon receiving access rights to software (e.g., from purchase of a software package), the user receives an e-mail with a web link providing access to an installable copy of the ToolBox. Then, the user downloads and installs the ToolBox, thus bootstrapping the entire software acquisition process. Typically, no physical media or product delivery is required. In a private ToolCloud™ system deployment inside an organization, the organization's system administrator will grant (appropriate) users access to certain software packages, whereupon an e-mail invitation is automatically generated and sent out to those users. Each e-mail includes a link to provision a ToolBox client for each user added to the system. The ToolBox, in turn, is the mechanism that users employ to obtain software product.

As shown in the figure, the ToolBox UI 300 includes a status pane 301 and a navigation panel 310. The status pane 301 displays the current system status, including information about who the user is currently logged in as (i.e., what username), what group the user belongs to, and what cloud(s) the user is connected to, as well as information about the currently selected application in the ToolBox's workspace (i.e., the product that the user has selected the corresponding thumbnail for).

The panel 310 on the other hand provides navigation features and contains the following items: Library 311, Store 313, “Toolclouds” 315, and Configurations 317. The functionality of each item is perhaps best described by examining use cases. After installing the ToolBox, the user first connects to one or more “clouds” and then “charges” the ToolBox. “Toolclouds” panel item 315 allows the user to indicate which cloud environment(s) (e.g., public “cloud” or private “cloud”) to connect to. The UI 300 includes a “Locate Cloud” feature that allows the user to search for different environments to connect to. Typically, the user connects to a public cloud and one or more private clouds within the user's organization.

After successful connection to at least one cloud, the user still has an “empty” ToolBox. Thus, the user now proceeds to “charge” the ToolBox, that is, fill it with software applications required by the user. Based on the credentials presented by the user, the currently-connected cloud server allows the user to charge the user's ToolBox with products and packages. Note that these credentials are automatically resolved against the available licenses, for the items that the user wishes to obtain. (The user may charge from available public and private clouds.) Each individual cloud presents items available to the given user. The user may select all available products, or pick and choose as appropriate. Once the user has completed selection, the (respective) cloud server begins streaming these products to the user's ToolBox. Once the user has charged the ToolBox, the products (e.g., application software) are displayed as available items in the ToolBox workspace 320. Now, a multitude of products (e.g., Delphi®, InterBase®, RapidSQL™, etc.) are available to the user, as shown in FIG. 3A. Each product is made available with its respective installer, so that the user can easily install the product by selecting the product icon from the workspace and launching the product's installer (by clicking Setup/Install button 350).

Each software application is made available as a special “Tool Cloud Application” (TCA). A TCA is a managed application that runs within a public or private tool cloud (including local ToolBoxes). It represents a component web application server or desktop application that fully exploits the services provided by the cloud server, including participating with the licensing services of the cloud server so as to provide activation enablement coupled with immediately available execution. The TCA is built by enabling an existing application or is built from scratch. TCAs allow the user to download and install a given software product (i.e., conventional installation) or instead run the software product instantly, by invoking an “Instant On” feature of the present invention. Instant-on access allows users to run software products without the friction or burden of installation.

The user interface for instant-on usage in the currently preferred embodiment is as follows. With the desired product selected (e.g., Delphi® is selected in the workspace 320, as indicated by highlight), the user clicks the Instant On glyph 330, whereupon the system runs the application (i.e., the full, rich application) without performing a full install of the product on the user's machine. Here, the system streams an executable version of the actual product to the user's machine (if not already streamed), and immediately launches its execution. The system of the present invention provides special packaging in the form of an executable archive that includes license management and related metadata, together with a virtualized file system and registry, that allows application software products to be streamed from the cloud server to the client for immediate execution (i.e., without waiting for installation at the client). In the currently preferred embodiment, the application binary (e.g., ultimately deployed .exe file) is pre-imaged (i.e., previously capture to disk) at the server and can therefore be streamed on-demand to the client for immediate execution. Additional efficiencies are achieved by virtue of the fact that only the application components (e.g., DLLs) necessary for execution are streamed to the client (in contrast to a traditional application, where many or most of the application's components must be unpacked at the local system for installation and execution).

Conventional virtualization technique can be employed to virtualize the file system and the registry used by the instant-on (streamed) application; the application binary itself executes natively (i.e., without virtualization). During execution of the instant-on application binary, the virtualized local file system supports creation of local objects, data structure, and files (e.g., DLLs), and any other items that the application expects (i.e., the virtualized execution environment is preconceived). This serves as a local sandbox for the instant-on application to write local data, including for instance configuration information. In this manner, the instant-on application is executed in a self-contained environment so that its impact on the user's computer can be minimized.

Registry settings are handled as follows. Applications not only expect to find a system registry (e.g., Microsoft Windows registry) but also expect to read and write to the registry during program operation. Here, the system of the present invention provides every application with its own virtualized private registry, which is integrated with the (real) operating system (e.g., Windows) registry. The integration is such that certain registry keys (i.e., data values) are virtualized, while others are simply deferred to the real registry. When a registry call is made for a particular registry key by an instant-on application, the virtualized registry is employed if the particular registry key itself has been virtualized. Otherwise, the call is simply passed through to the operating system (OS) and hence the OS registry. In a similar fashion decisions are made regarding the virtualized file system versus the real (operating system) file system. Consider, for example, instant-on use of an application offered by a cloud's library, such as Embarcadero Technologies' Delphi® (development tool), Microsoft® Word (word processor), or Adobe® Photoshop (bitmap and photo editor). In each case, the end user's normal use of the instant-on application results in the creation of user documents (e.g., Delphi® source code file, Word document file, or Photoshop document file). These are saved to the real file system. Changes to the application itself that are stored to the file system (e.g., non-registry configuration information), on the other hand, are saved to the virtual file system.

Each instant-on application can be maintained on the user's computer as a cached application, or it may be deleted and streamed at a future date. Applications that are in the user's cache of applications are listed under Library 311. Whereas each cloud represents software applications that are available, the Library represents applications that the user has placed in the ToolBox. For the example shown in the figure, the user has 18 local applications under All Access (licensed under a single “All Access” pass), and 6 applications under MyApps (e.g., internal applications or third-party applications). In a manner similar to virtualization of software applications, servers (e.g., MySQL server) can be virtualized and made available under Library 311 as a “virtual server” (i.e., a virtual instance of a server). This is especially useful for those users who are developers. For example, consider a developer user who is developing a product against five databases. Using the system of the present invention, an administrator need only create five different virtualized versions of those databases and then make those available to the firm's developer users.

Each cloud represents a collection of things that are licensed or built (e.g., by a corporation or firm). Apart from “cloud” products (i.e., already licensed products), the navigation panel 310 includes a “store” (Store 313) where one can acquire new software or other products. FIG. 3B is a bitmap screenshot illustrating selection of “Marketplace” (314) within the Store 313. As shown, the workspace of the user interface lists items available for purchase in the public marketplace (public cloud), thus serving as a gateway to products not currently within one of the other clouds. Purchased items can be either placed directly into the user's Library or into a cloud (e.g., firm's private tool cloud, managed by the firm's administrator and/or users).

The system of the present invention facilitates configuration management by allowing the administrator to create different ToolBox configurations and assign each to a particular group of users. For example under Configurations 317 in FIG. 3A, the system administrator has created an AppDev configuration (e.g., for the firm's application developer users) and a Testing configuration. This allows the administrator to configure the interface so that testers (testing employees) only see testing tools. In this manner, the administrator can control which users see particular applications offered as available from the clouds. Similarly, Configurations 317 can be used to create different application environment configurations. For example, an administrator may create and manage various Eclipse™ configurations (Team 1 configuration, Team 2 configuration, etc.), for various teams that an organization may have. One of the configurations, for instance, may be “locked down” to prevent user changes to the configuration.

The centralized management of applications provided by the system of the present invention enables real-time tracking of licenses and usage. FIG. 3C is a bitmap screenshot illustrating a report workspace 360 provided by the system for real-time license tracking and usage reports. These reports reflect transactions that are happening in the background against each cloud server.

### Detailed Operation

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server). For purposes of the following discussion, it is assumed that the system (i.e., system 200) has already been deployed, so that the ToolBox (client agent) is installed at the user's machine and at least one cloud server is online and available for providing services to that ToolBox. As previously described, the system may send a given user an e-mail invitation to download and install the ToolBox (from a web link embedded in the e-mail). Exemplary methods of operation are as follows.

A. Software Procurement

(1) General Process

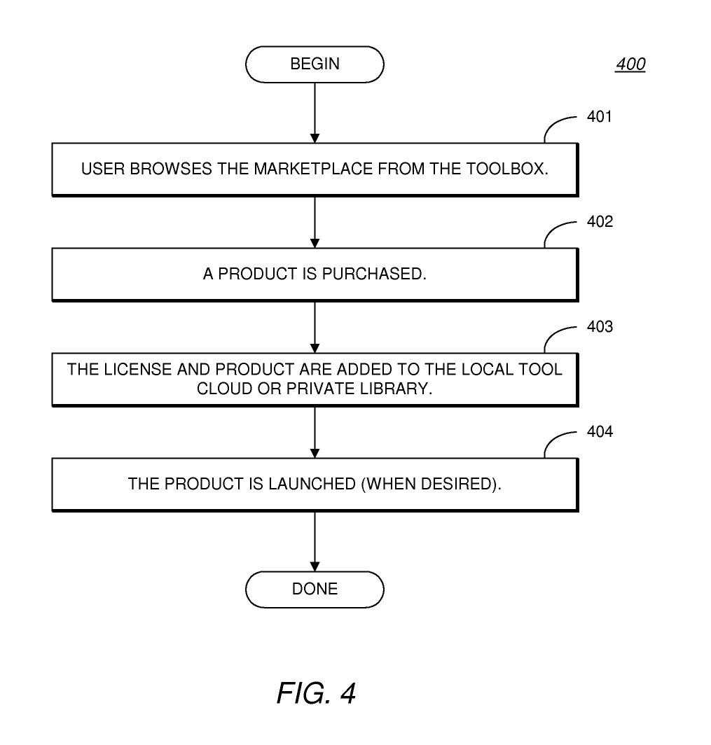

FIG. 4 is a high-level block flow diagram illustrating a method 400 of the present invention for procuring applications, for example by purchasing applications from the public cloud or “Marketplace.” At step 401, a user (i.e., end user) can browse the store from within the ToolBox; filtering by criteria (e.g., vendor, product, category, etc.) is available. A product can be purchased with the user's account at 402, performed using conventional e-commerce/shopping cart technology, with the download being managed by the ToolBox. Depending on the license selection, the product is downloaded to the ToolBox or to the local tool cloud. In the case of network named user licensing and concurrent licensing the download is to the tool cloud, which manages concurrent usage/provisioning. In the case of per seat or node-locked license, the download is to the ToolBox. In both cases the license (slip file) is retrieved from the store and configured automatically at 403. The software product is launched on-demand, as indicated at step 404.

(2) Internal Operation

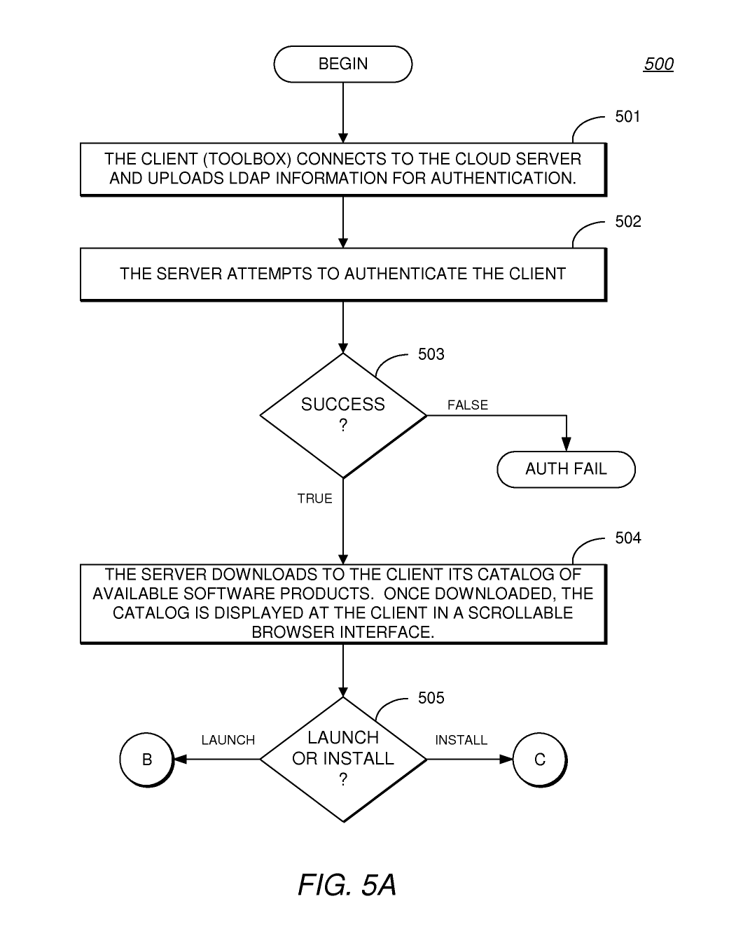

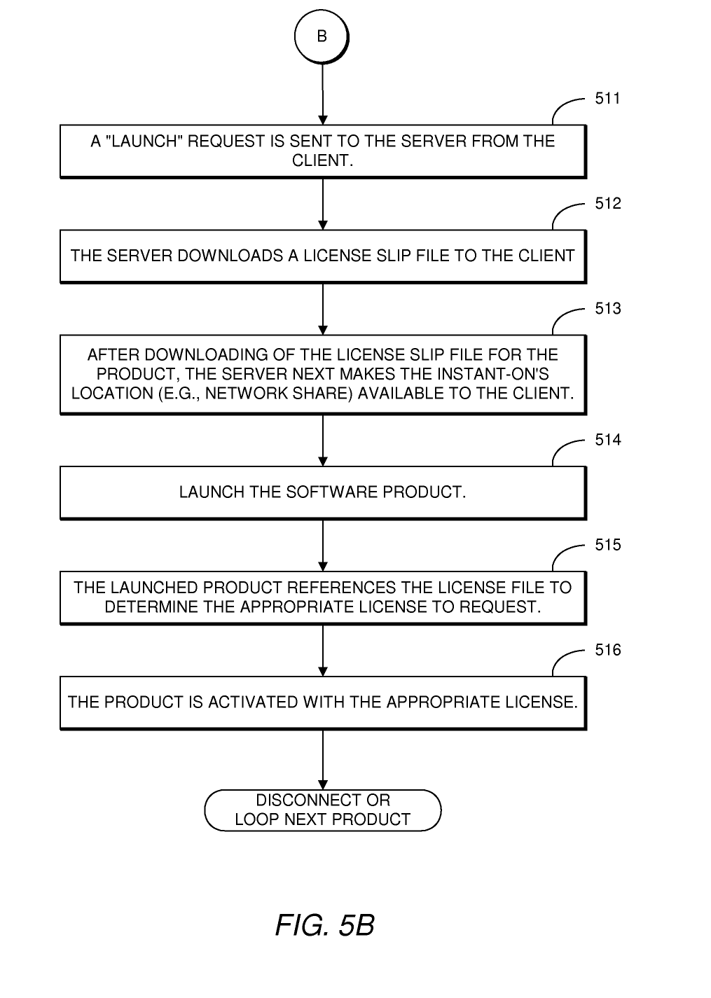

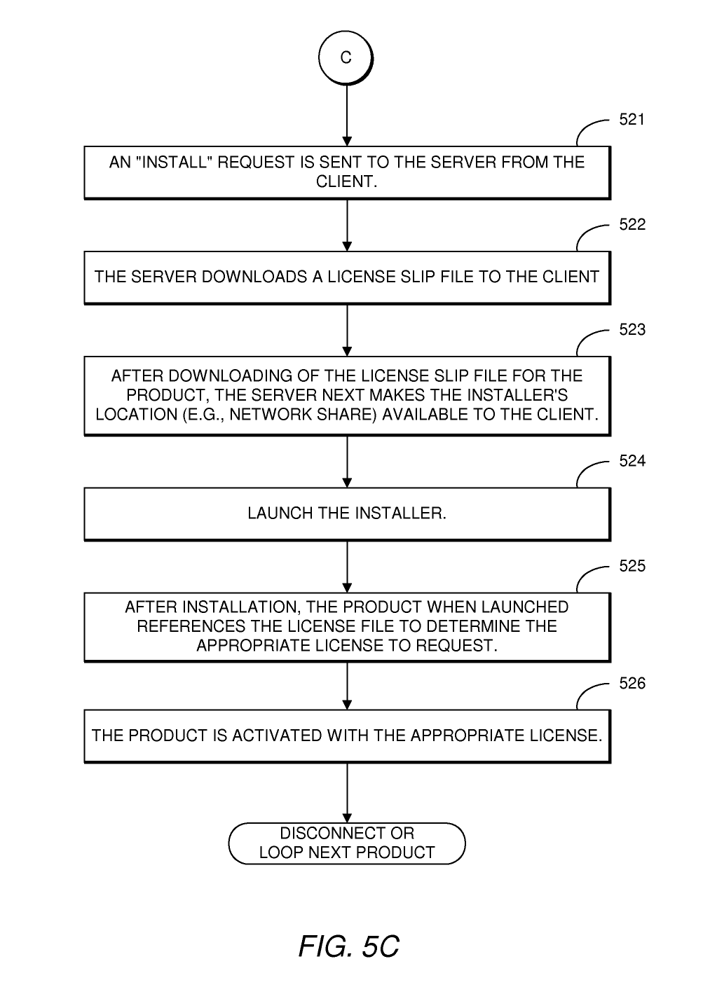

FIGS. 5A-C comprise a detailed flow diagram illustrating a method 500 for automating the delivery, licensing, and availability of application software. The method steps are as follows. At step 501, the client (i.e., ToolBox, under end user control) connects to the cloud server. Here, the client uploads LDAP information for authentication. Upon receiving this information, the server attempts to authenticate the client at step 502. Authentication at this point is guided by the permission model in place at the deployment. For example, a simple permission model is to accept all users (e.g., of a given firm), with each new user connecting to the server being registered and associated with a default license (i.e., default license for a new user on that cloud). If authentication succeeds (i.e., “true” at step 503), the method may proceed to the next step (step 504). Otherwise (i.e., “false” at step 503), authentication fails and the method terminates. At step 504, the server downloads to the client its catalog of available software products. Once downloaded, the catalog is displayed at the client in a scrollable browser interface (as previously described above).

At this point, the end user may elect to configure a product or launch a product, as indicated by step 505. In the event that the user elects to launch a software product (i.e., instant-on product), the method proceeds to the steps illustrated in FIG. 5B. At step 511, a “launch” request is sent to the server from the client. In response to this request, the server downloads a license slip file to the client, as shown at step 512. (In the case that a more complex permission model is in place at the deployment, additional access control steps are taken to verify that the request is permitted.) The slip file itself is a license metadata file indicating how the client is licensed (e.g., concurrent user license). The launched product refers to the license slip file in order to obtain the license it needs to operate. After downloading of the license slip file for the product, the server next makes the product's location (e.g., network share) available to the client, as indicated at step 513. Now, the client (ToolBox) launches the software product, at step 514. (Optionally at this point, the user can select a particular version and/or configuration of the product, before launching.) Upon being launched, the product references the license file to determine the appropriate license to request (i.e., one appropriate to this client's use of the product), at step 515. Finally, at step 516, the product is activated with the appropriate license, thus permitting the client to proceed with licensed use of the product. Thereafter, the client may continue the cloud session (for this or other products), or the client may disconnect.

In the event that the user elects to install a software product (i.e., not instant-on product), the method proceeds to the steps illustrated in FIG. 5C. The workflow is similar to the instant-on workflow; however, the result is very different by virtue of the application's installer being downloaded. The steps are as follows. At step 521, an “install” request is sent to the server from the client. In response to this request, the server downloads a license slip file to the client, as shown at step 522. (If desired, additional access control steps can be taken to verify that the request is permitted.) Again, the slip file itself represents an informational file indicating how the client is licensed (or can obtain an appropriate license from the cloud). The installed product, once launched, refers to the license slip file in order to obtain the license it needs to operate. After downloading of the license slip file for the product, the server next makes the location of the product's installer (e.g., network share) available to the client, as indicated at step 523. Now, the installer for the software product is launched, at step 524. (As was the case with instant-on, the user can optionally select a particular version and/or configuration of the product, before installation.) Upon being installed and then launched, the product references the license file to determine the appropriate license to request (i.e., one appropriate to this client's use of the product), at step 525. Finally, at step 526, the fully-installed product is activated with the appropriate license, thus permitting the client with licensed use of the product. Thereafter, the client may continue the cloud session (for this or other products), or the client may disconnect.

B. Construction of a Tool Cloud Application (TCA)

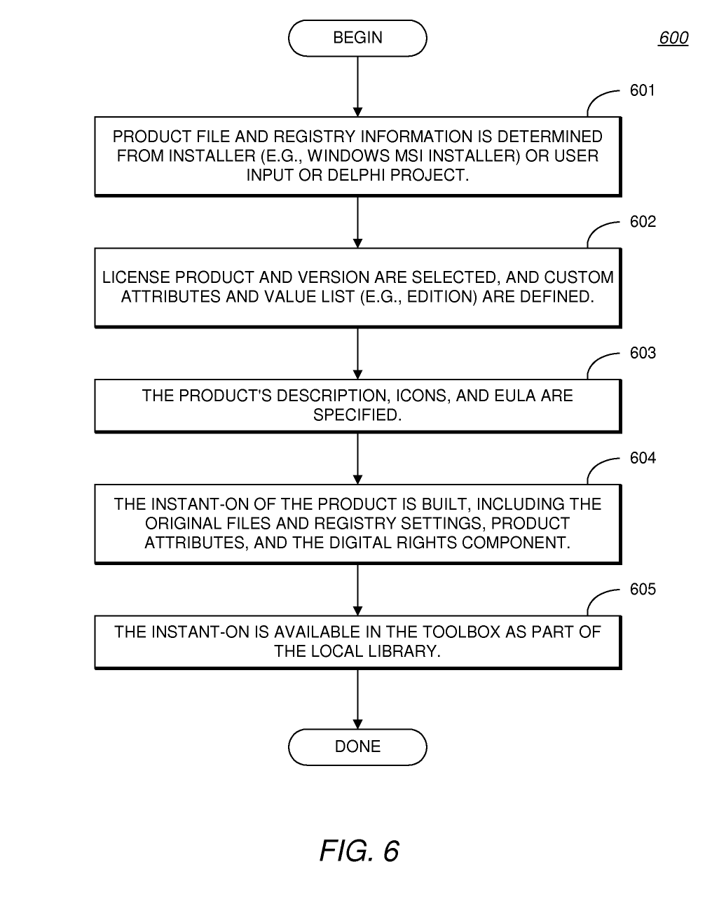

FIG. 6 is a detailed flow diagram illustrating a method 600 of the present invention for converting an existing install file (e.g., Microsoft Windows Installer .MSI install file) into an instant-on application that runs with appropriate file and registry settings, as well as protected (virtual) file and registry settings. The ToolBox includes allows the customer or administrator user (i.e., user upstream from the end user) to create, from an existing install file (e.g., Microsoft Windows Installer .MSI install file), an instant-on program that is fully licensed and works (i.e., run on a user machine) without having to actually install the program (e.g., execute the .MSI Installer). Detailed information about the Microsoft Windows Installer and MSI files is available on the Microsoft Developer Network (MSDN), for example currently at MSDN Library|Win32 and COM Development|Administration and Management|Application Installation and Services|Windows Installer. Those skilled in the art, enabled by the teachings herein, will appreciate that the method need not be tied to the Microsoft Windows Installer but can instead by adapted for other installers.

The method 600, which is performed by a Tool Cloud Application wizard, proceeds as follows. Contained within the pre-existing install file is information about file usage (e.g., directory set up) and registry settings. At step 601, a Tool Cloud Application (TCA) model is populated with information about the application being enabled for the Tool Cloud distribution. The TCA model can be populated from a variety of sources including an MSI installer (e.g., Microsoft Windows Installer), an Embarcadero® RAD Studio Delphi® or C++ project, or a custom application. A listing of files organized by common directories (e.g., program files, application data, etc.) is managed by the model as is a listing of registry settings and environment variables. The ToolBox determines the product file and registry information from the installer (e.g., Windows Installer) or received as input from the user (e.g., employee of the product's vendor) or project settings. For example, this information may be interpreted from an MSI installer by parsing out the MSI contents, extracting all files, registry keys and values, environment variables, and any custom actions executed by the installer. This allows the ToolBox to determine, for example, what default install location and special registry keys are set during (normal) installation of the program. Any custom actions are executed separately with all interactions with the file system, registry and environment variables being intercepted and replaced with a virtual environment so as not to affect any changes on the actual system. Each element in the TCA file is assigned identifying attributes to indicate their position in the instant-on application. Some files remain private to the application and others are written to the host system and are visible to the host environment. Preferably, this file and registry information is displayed to the ToolBox user together with an application GUID (globally unique identifier) specified by the installer (e.g., Windows Installer), with the user given the option to edit the information and/or add new information.

Now, the licensed product (e.g., activation for concurrent seat license) and version are selected (e.g., by the ToolBox user, from the ToolBox user interface), and any custom attributes and value list (e.g., edition) are defined. At step 602, therefore, the user interacts with the licensing server to create an account and configure the application's license settings. Each license belongs to a product with a version and can have custom attributes defined. The attributes are encrypted into each generated license and can be read by the licensed application to gain information about the assigned license. For added security, the user has the option to embed license checks within their application source code. Information embedded in this way can limit the functionality of the application based on the assigned license. In the background, selection of the licensed product triggers a call to a licensing server (Embarcadero Licensing Server) to allow the ToolBox user to input licensing parameters or attributes. In response to these input parameters, the licensing server creates the license “slip file” to be deployed with the instant-on application (which, at execution, checks the slip file for appropriate licensing rights). If desired the ToolBox user can embed additional licensing checks within the product's code. For example at strategic points during product installation or usage (including upsell features), the product's code may invoke licensing calls (ToolBox “Check License” API call) to confirm the current licensing status. Thereafter, at step 603, the product's name and description, icons (for the instant-on executable), and end user license agreement are specified. These are included in the model. Other instant-on relevant metadata, such as a “splash screen,” may be specified at this point. In typical usage, the product metadata (e.g., name, icons, splash screen, EULA, etc.) specified for the instant-on application will correlate closely to the regular (i.e., non-instant-on) application.

At step 604, the instant-on product is built/emitted using the information in the TCA model. Here, the system takes all of the information and components parsed from the pre-existing install file and combines that with the above-specified ToolBox user input (i.e., configuration information and metadata) and license information (including any optional checkpoints), to generate a self-contained standalone instant-on executable (e.g., .exe) file that end users may download and run. The instant-on application includes or is in communication with a license application (or embedded program logic) that serves as the gate keeper to the user application. Now that the instant-on executable has been created, it can be copied over to the ToolBox library, as indicated at step 605. The instant-on application can be accessed from the library by selecting (e.g., double-clicking) it, as well as exported to other libraries for access by other users. When an end user launches the instant-on, the license application checks for a valid license or prompts the user to license it. When a valid license is found, the user application is launched.

C. Publication of the Tool Cloud Application (TCA) to the Local Cloud and/or Marketplace

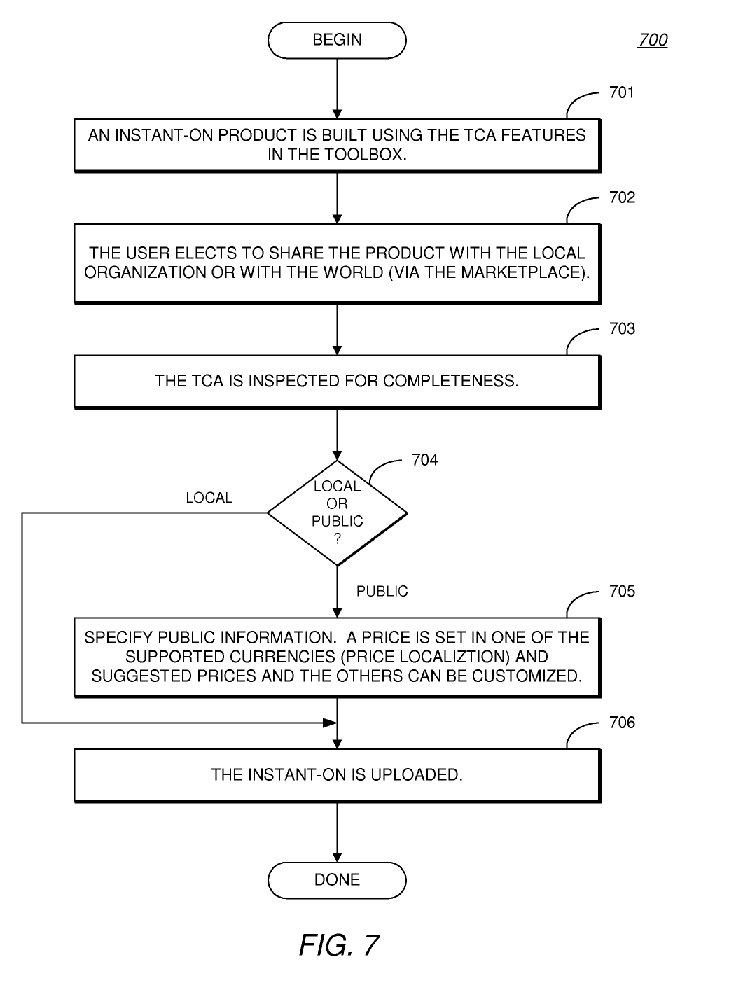

FIG. 7 is a detailed flow diagram illustrating a method 700 for uploading or publishing the Tool Cloud Application (TCA) to a local tool cloud or public tool cloud (“Marketplace”). At step 701, the user launches the TCA wizard to create a tool cloud enabled application (TCA) as previously described (method 600). An existing application can be edited using a tabbed workspace integrated right inside the ToolBox. The instant-on file is produced and is available to be run in the local ToolBox. Once the ToolBox user is ready to publish the instant-on application, the user chooses to share the instant-on with either a local tool cloud (his or her organization) or with a public tool cloud (i.e., “Marketplace” or public store) at step 702. At step 703, the TCA is inspected for completeness.

If the user is sharing the TCA publicly with the Marketplace, tested at step 704, additional content is specified at step 705 for the public store, including a description of the product, a graphic, and pricing. Pricing can be set by product variant or for the product. A product that sells by edition can have a unique price specified for each edition. Variants are specified in the license and are defined when building a license for the application. A price can be set in one of the supported currencies, including Yen, US Dollar, Euro, British Pound, and the like. When the price is set, it is converted at current exchange rates to all other supported currencies. If desired, the user then can edit those prices to round them nicely or account for reasonable pricing and market differences, or the like. Finally, at step 706, the instant-on application is uploaded to the Marketplace or local cloud and is now available to end users having approved access. At this step, the ToolBox user uploading to the Marketplace is required to have appropriate vendor approval, that is, a vendor that is preapproved by the cloud server authority (e.g., Embarcadero Technologies, Inc.). Optionally, the authority may impose administrative clearance requirements before a given instant-on application is made available from the Marketplace.

D. Source Code Implementation

(1) Connect to ToolCloud and Display Products Implementation Details

In accordance with the present invention, the above described operations are implemented as Web-based services (“Web Services”). In order to work with Web Services exposed by the ToolCloud and ToolBox, Embarcadero® RAD Studio's Web Service (Embarcadero Technologies, San Francisco, Calif.) importer tool is employed to generate an interface for the Web Service imported with member methods that maps Web Service methods and a function to create instances of such interfaces. For example, the following interface is generated for productWebService_v10 (authored in Embarcadero® RAD Object Pascal):

| 1: | // ***************************************************************** // | | |
|---|---|---|---|
| 2: | // Namespace | : | http://v10.ws.server.allaccess.embarcadero.com |
| 3: | // transport | : | http://schemas.xmlsoap.org/soap/http |
| 4: | // style | : | document |
| 5: | // binding | : | productWebService_v10HttpBinding |
| 6: | // service | : | productWebService_v10 |
| 7: | // port | : | productWebService_v10HttpPort |
| 8: | // URL | : | |

http://ruspd-dtitov2/aaserver/services/productWebService_v10

| | |
|---|---|
| 9: | // ***************************************************************** // |
| 10: | productWebService_v10PortType = interface(IInvokable) |
| 11: | [‘{5FCEA1ED-057F-5C50-AF02-D0E2869993CF}’] |
| 12: | function getAllAccessLicensesLocation(const in0: string): |

ArrayOfString; stdcall;

| | |
|---|---|
| 13: | function getAllAccessLicenseLocation(const in0: string): string; |

stdcall;

| | |
|---|---|
| 14: | function getProductsByConfigId(const in0: string; const in1: |

string): ArrayOfProduct; stdcall;

| | |
|---|---|
| 15: | function getDocumentForVersion(const in0: string; const in1: |

string; const in2: string): ArrayOfDocument; stdcall;

| | |
|---|---|
| 16: | function getAllProducts(const in0: string): ArrayOfProduct; |

stdcall;

| | |
|---|---|
| 17: | function getProducts(const in0: string): ArrayOfProduct; stdcall; |
| 18: | function getBuildsByConfiguration(const in0: string; const in1: |

string): ArrayOfBuildFile; stdcall;

| | |
|---|---|
| 19: | function retrieveTrialLicenses(const in0: string; const in1: |

string; const in2: string; const in3: string):
ArrayOfTrialLicenseFile; stdcall;

| | |
|---|---|
| 20: | end; |
| 21: | |
| 22: | function GetproductWebService_v10PortType(UseWSDL: |

Boolean=System.False; Addr: string=‘’; HTTPRIO: THTTPRIO = nil):
productWebService_v10PortType;

Similarly, the following interface may be declared for UserManagementWebService_v20:

| 1: | // ****************************************************************** // | | |
|---|---|---|---|
| 2: | // Namespace | : | http://v20.ws.server.allaccess.embarcadero.com |
| 3: | // transport | : | http://schemas.xmlsoap.org/soap/http |
| 4: | // style | : | document |
| 5: | // binding | : | userManagementWebService_v20HttpBinding |
| 6: | // service | : | userManagementWebService_v20 |
| 7: | // port | : | userManagementWebService_v20HttpPort |
| 8: | // URL | : | |

http://localhost:808/aaserver/services/userManagementWebService_v20

| | |
|---|---|
| 9: | // ******************************************************************** // |
| 10: | userManagementWebService_v20PortType = interface(IInvokable) |
| 11: | [‘{5F0C7739-C6D3-DA20-775D-F37E7780D6D7}’] |
| 12: | function getAllConfigurations(const in0: string; const in1: |

ArrayOfString): ArrayOfWsConfiguration; stdcall;

| | |
|---|---|
| 13: | procedure resetPassword(const in0: string; const in1: Integer; |

const in2: string); stdcall;

| | |
|---|---|
| 14: | function getUsersForConfigId(const in0: string; const in1: |

string): ArrayOfWsUser; stdcall;

| | |
|---|---|
| 15: | function getSubGroupsForGroupId(const in0: string; const in1: |

string): ArrayOfWsGroup; stdcall;

| | |
|---|---|
| 16: | function modifyUserGroup(const in0: string; const in1: string; |

const in2: string; const in3: string; const in4: ArrayOfString; const
in5: ArrayOfString;

| | |
|---|---|
| 17: | const in6: ArrayOfString): WsGroup; |

stdcall;

| | |
|---|---|
| 18: | procedure removeUserGroup(const in0: string; const in1: string); |

stdcall;

| | |
|---|---|
| 19: | function modifyUser1(const in0: string; const in1: string; const |

in2: string; const in3: string; const in4: string; const in5:
ArrayOfString

| | |
|---|---|
| 20: | ): WsUser; stdcall; |
| 21: | function getUsersForGroupId(const in0: string; const in1: |

string): ArrayOfWsUser; stdcall;

| | |
|---|---|
| 22: | function getGroupsForConfigId(const in0: string; const in1: |

string): ArrayOfWsGroup; stdcall;

| | |
|---|---|
| 23: | procedure removeConfiguration(const in0: string; const in1: |

string); stdcall;

| | |
|---|---|
| 24: | procedure assignConfiguration2Groups(const in0: string; const |

in1: string; const in2: ArrayOfString; const in3: ArrayOfString);
stdcall;

| | |
|---|---|
| 25: | procedure removeUser(const in0: string; const in1: string); |

stdcall;

| | |
|---|---|
| 26: | function getGroupsForUserId(const in0: string; const in1: |

string): ArrayOfWsGroup; stdcall;

| | |
|---|---|
| 27: | function getAllUserGroups(const in0: string; const in1: |

ArrayOfString): ArrayOfWsGroup; stdcall;

| | |
|---|---|
| 28: | function login(const in0: string; const in1: string): string; |

stdcall;

| | |
|---|---|
| 29: | function getConfigurationsForUserId(const in0: string; const |

in1: string; const in2: Boolean): ArrayOfWsConfiguration; stdcall;

| | |
|---|---|
| 30: | procedure assignConfiguration2Users(const in0: string; const in1: |

string; const in2: ArrayOfString; const in3: ArrayOfString); stdcall;

| | |
|---|---|
| 31: | function registerUser(const in0: string; const in1: string): |

WsUser; stdcall;

| | |
|---|---|
| 32: | function getAllUsers(const in0: string; const in1: |

ArrayOfString): ArrayOfWsUser; stdcall;

| | |
|---|---|
| 33: | function createConfiguration(const in0: string; const in1: |

string; const in2: string; const in3: string; const in4: string;
const in5: ArrayOfProduct

| | |
|---|---|
| 34: | ): WsConfiguration; stdcall; |
| 35: | function getParentGroupsForGroupId(const in0: string; const in1: |

string): ArrayOfWsGroup; stdcall;

| | |
|---|---|
| 36: | function modifyConfiguration(const in0: string; const in1: |

string; const in2: string; const in3: string; const in4: string;
const in5: string;

| | |
|---|---|
| 37: | const in6: ArrayOfProduct): |

WsConfiguration; stdcall;

| | |
|---|---|
| 38: | function createUser(const in0: string; const in1: string; const |

in2: string; const in3: string; const in4: ArrayOfString): WsUser;
stdcall;

| | |
|---|---|
| 39: | function getPrivileges(const in0: string): ArrayOfString; |

stdcall;

| | |
|---|---|
| 40: | function modifyUser(const in0: string; const in1: string; const |

in2: string; const in3: string; const in4: ArrayOfString): WsUser;
stdcall;

| | |
|---|---|
| 41: | function login1(const in0: string; const in1: string; const in2: |

string): string; stdcall;

| | |
|---|---|
| 42: | function createUserGroup(const in0: string; const in1: string; |

const in2: string; const in3: ArrayOfString; const in4:
ArrayOfString; const in5: ArrayOfString

| | |
|---|---|
| 43: | ): WsGroup; stdcall; |
| 44: | procedure changePassword(const in0: string; const in1: string); |

stdcall;

| | |
|---|---|
| 45: | function getConfigurationsForGroupId(const in0: string; const |

in1: string; const in2: Boolean): ArrayOfWsConfiguration; stdcall;

| | |
|---|---|
| 46: | end; |
| 47: | function GetuserManagementWebService_v20PortType(UseWSDL: |

Boolean=System.False; Addr: string=‘’; HTTPRIO: THTTPRIO = nil):
userManagementWebService_v20PortType;

During toolcloud login phase, an instance of the above defined userManagementWebService_v20 interface is created. The interface's login method (defined at line 28) is called with login parameters either provided by the user or ToolBox itself. This login to the toolcloud call is initiated by a toolcloud instance (i.e., instance of TToolCloud class) which models a toolcloud inside ToolBox application; the toolcloud class, TToolCloud, may be defined as follows:

| 1: | TToolCloud = class( TEntity ) | |
|---|---|---|
| 2: | private | |
| 3: | FName: string; | |
| 4: | FPort: Word; | |
| 5: | FIsPortSet: boolean; | |
| 6: | FAddress: string; | |
| 7: | FWSDLPathOnServer: string; | |
| 8: | FSessionID: string; | |
| 9: | | |
| 10: | FGroupMode: | TGroupProductsMode; |
| 11: | FCloudType: | TToolCloudType; |
| 12: | FOnConnectionFailed: | TNotifyEvent; |
| 13: | FOnLoginFailed: | TNotifyEvent; |

| 14: | | |
|---|---|---|
| 15: | function | getName: string; |
| 16: | function | getAddress: string; |
| 17: | function | getPort: Word; |
| 18: | procedure | setName(const Value: string); |
| 19: | procedure | setAddress(const Value: string); |
| 20: | procedure | setPort(const Value: Word); |
| 21: | function | getWSDLPathOnServer: string; |
| 22: | procedure | SetWSDLPathOnServer(const Value: string); |
| 23: | function | getIsPortSet: boolean; |
| 24: | function | getIsServerAddressSet: boolean; |
| 25: | function | getIsWSDLPathOnServerSet: boolean; |
| 26: | | |
| 27: | function | getGroupMode: TGroupProductsMode; |
| 28: | function | getIsPublic: Boolean; |
| 29: | function | getLoginSuccessful: Boolean; |
| 30: | | |
| 31: | function | getSessionID: string; |
| 32: | | |
| 33: | protected | |
| 34: | procedure | DoValidate( const Errors: IValidationErrors ); override; |

| | |
|---|---|
| 35: | |
| 36: | public |
| 37: | const DefaultName = ‘Public’; |
| 38: | const DefaultWSDLString = |

‘/aaserver/services/productWebService_v10?wsdl’; //default WSDL path

| | |
|---|---|
| 39: | const DefaultUsageStatisticsWSDLString = |

‘/aaserver/services/usageStatisticsWebService_v20?wsdl’; //default
WSDL path for Usage statistics

| | |
|---|---|
| 40: | const DefaultUserManagementWSDLString = |

‘/aaserver/services/userManagementWebService_v20?wsdl’;

| | |
|---|---|
| 41: | const DefaultProfilesWSDLString = |

‘/aaserver/services/profileBrowsingWebService_v10?wsdl’;

| | |
|---|---|
| 42: | const DefaultProfilesDownloadString = |

‘/aaserver/provisioningService?cmd=downloadProfileVersion&id=’;

| | |
|---|---|
| 43: | |
| 44: | |
| 45: | const DefaultServerAddress = ‘http://localhost’; //default server |
| 46: | const DefaultPort = 80; //default port; |
| 47: | |
| 48: | constructor Create; overload; |
| 49: | constructor Create( Name: string; ServerAddress:string; Port:word; |
| 50: | CloudType: TToolCloudType ); overload; |
| 51: | |
| 52: | procedure Assign( Other: TToolCLoud ); |
| 53: | |
| 54: | function getURLforWSDL( ): string; //get the full URL get get the |

WSDL on this ToolCloud server

| | |
|---|---|
| 55: | function getURLforUsageStatisticsWSDL( ): string; //get the full |

URL get usage statistics WSDL on this ToolCloud server

| | |
|---|---|
| 56: | function getURLForUserManagementWSDL( ): string; |
| 57: | function getURLforProfilesWSDL( ): string; |
| 58: | function getURLforProfileDownload(ProfileVersionId:integer): |

string;

| | |
|---|---|
| 59: | |
| 60: | function getErrorMessage( ErrorCode: Integer ): string; |
| 61: | |
| 62: | function Login( User: TToolBoxUser ): integer; |
| 63: | function Connect( User: TToolBoxUser ): integer; |
| 64: | function RegisterUser( User: TToolBoxUser ): integer; |
| 65: | function Connected: Boolean; |
| 66: | |
| 67: | procedure LoginFailed; |
| 68: | procedure ConnectionFailed; |
| 69: | |
| 70: | published |
| 71: | property Name: string read getName write setName; |
| 72: | property ServerAddress: string read getAddress write setAddress; |

//ToolCloud server address

| | |
|---|---|
| 73: | property Port: Word read getPort write setPort; //0 to 65535 |

//ToolCloud server port

| | |
|---|---|
| 74: | |
| 75: | public |
| 76: | property WSDLPathOnServer: string read getWSDLPathOnServer write |

SetWSDLPathOnServer; // path to the WSDL on this Tool Cloud server

| | |
|---|---|
| 77: | property IsPublic: Boolean read getIsPublic; |
| 78: | |
| 79: | property IsServerAddressSet: boolean read getIsServerAddressSet; |

// if False the DefaultServerAddres will be used

| | |
|---|---|
| 80: | property IsPortSet: boolean read getIsPortSet; //if False the |

DefaultPort will be used

| | |
|---|---|
| 81: | property isWSDLPathOnServerSet: boolean read |

getIsWSDLPathOnServerSet; // //if False the DefaultWSDLString will be
used

| | |
|---|---|
| 82: | |
| 83: | property ProductGroupMode: TGroupProductsMode read getGroupMode |

write FGroupMode;

| | |
|---|---|
| 84: | |
| 85: | property SessionID: string read getSessionID write FSessionID; |
| 86: | property LoginSuccessful: Boolean read getLoginSuccessful; |
| 87: | |
| 88: | property OnConnectionFailed: TNotifyEvent read |

FOnConnectionFailed write FOnConnectionFailed;

| | |
|---|---|
| 89: | property OnLoginFailed: TNotifyEvent read FOnLoginFailed |

write FOnLoginFailed;

| | |
|---|---|
| 90: | end; |
| 91: | |
| 92: | function TToolCloud.Login(User: TToolBoxUser): integer; |
| 93: | begin |
| 94: | Result := Connect( User ); |
| 95: | |
| 96: | if Result = Globals.SUCCESS then |
| 97: | // get user privileges |
| 98: | Result := AdministrationProvider.getPrivileges( FSessionID, |
| 99: | |

getURLForUserManagementWSDL,

| | |
|---|---|
| 100: | User.Privileges ); |

| | |
|---|---|
| 101: | end; |

Of particular interest are the Login and Connect member functions or methods of the class:

| | |
|---|---|
| 1: | function TToolCloud.Login(User: TToolBoxUser): integer; |
| 2: | begin |
| 3: | Result := Connect( User ); |
| 4: | |
| 5: | if Result = Globals.SUCCESS then |
| 6: | // get user privileges |
| 7: | Result := AdministrationProvider.getPrivileges( |
| | FSessionID, |
| 8: | |

getURLForUserManagementWSDL,

| | |
|---|---|
| 9: | User.Privileges ); |
| 10: | end; |
| 11: | |
| 12: | |
| 13: | function TToolCloud.Connect(User: TToolBoxUser): integer; |
| 14: | var |
| 15: | cursor: TCursor; |
| 16: | begin |
| 17: | try |
| 18: | cursor := Screen.Cursor; |
| 19: | Screen.Cursor := crHourGlass; |
| 20: | |
| 21: | Result := AdministrationProvider.loginUser( self, User ); |
| 22: | finally |
| 23: | Screen.Cursor := cursor; |
| 24: | end; |
| 25: | end; |

As shown, the Login method receives a TToolBoxUser instance that encapsulates all the parameters required to login and starts the login flow, by calling the Connect method. The Connect method authenticates the user and opens a Toolcloud session. The Connect method, after handling some UI aspects, defers internally the call to a login User method (defined in AdministrationProvider unit) for the purpose of handling all the details of invoking Web Services and converting the parameters to/from Web Service format and ToolBox format. The AdministrationProvider unit itself may be constructed as follows (portions removed for clarity of the present discussion):

| | |
|---|---|
| 1: | unit AdministrationProvider |
| 2: | |
| 3: | interface |
| 4: | |
| 5: | [...] |
| 6: | function loginUser( ToolCloud: TToolCloud; User: TToolBoxUser): |

integer;

| | |
|---|---|
| 7: | [...] |
| 8: | function getPrivileges( SessionID, URLforWDSL: string; Privileges: |

TList<string> ): integer; overload;

| | |
|---|---|
| 9: | |
| 10: | implementation |
| 11: | |
| 12: | [...] |
| 13: | function loginUser( ToolCloud: TToolCloud; User: TToolboxUser ): |

integer;

| | |
|---|---|
| 14: | var |
| 15: | umws: userManagementWebService_v20PortType; |
| 16: | begin |
| 17: | ToolCloud.SessionID := ‘’; |
| 18: | |
| 19: | try |
| 20: | umws := |

GetuserManagementWebService_v20PortType(True,ToolCloud.
getURLForUserManagementWSDL);

| | |
|---|---|
| 21: | |
| 22: | if umws <> nil then |
| 23: | begin |
| 24: | ToolCloud.SessionID := umws.login1(User.Domain, User.Username, |

user.Password);

| | |
|---|---|
| 25: | Result := Globals.SUCCESS; |
| 26: | end; |
| 27: | |
| 28: | except |
| 29: | on E: Exception do Result := HandleWSException( E ); |
| 30: | |
| 31: | end; |
| 32: | end; |
| 33: | |
| 34: | [...] |
| 35: | function getPrivileges( SessionID, URLforWDSL: string; Privileges: |

TList<string> ): integer; overload;

| | |
|---|---|
| 36: | var |
| 37: | umws: userManagementWebService_v20PortType; |
| 38: | begin |
| 39: | Privileges.Clear; |
| 40: | |
| 41: | try |
| 42: | umws := GetuserManagementWebService_v20PortType( True, URLForWDSL |

);

| | |
|---|---|
| 43: | |
| 44: | if umws <> nil then |
| 45: | begin |
| 46: | Privileges.AddRange( umws.getPrivileges(SessionID) ); |
| 47: | Result := Globals.SUCCESS; |
| 48: | end; |
| 49: | |
| 50: | except |
| 51: | on E: Exception do Result := HandleWSException( E ); |
| 52: | |
| 53: | end; |
| 54: | end; |

The loginUser method (line 13) creates internally an instance of userMamanegent WebService (umws) by calling GetuserManagementWebService_v20PortType with the URL for WebService as its main parameter; it also invokes the Login method, passing in the required login parameters: Domain, Username and Password. When login is successful, the toolcloud sends back a SessionID value to identify the user session on that ToolCoud, which is kept for subsequent calls to WebService methods in the SessionID member of the ToolCloud instance. In case of login failure, a specific exception is thrown by ToolCoud, which is handled by a try . . . except block (lines 19-31 above) and converted to a ToolBox internal error code. This error code is processed by modules that initiated the ToolCloud connect flow and is displayed in a user friendly format within error message box.

The retrieval of toolcloud products is achieved with the help of a TToolCloudsPresenter class, which may be defined as follows (portions omitted for clarity of discussion):

| 1: | TToolCloudsPresenter = class( TPresenter ) | |
|---|---|---|
| 2: | | |
| 3: | type | |
| 4: | TConnectToToolCloud = class( TInterfacedInstance, IAction ) | |
| 5: | protected | |
| 6: | FActionImpl: | IActionImpl; |
| 7: | FPresenter: | TToolCloudsPresenter; |
| 8: | | |

| | |
|---|---|
| 9: | FConnectParams: TLoginParams; |
| 10: | |
| 11: | function Connect: LRESULT; |
| 12: | |
| 13: | { IInstance } |
| 14: | function IsEqual( Instance: IInstance ): Boolean; override; |
| 15: | |
| 16: | public |
| 17: | constructor Create( Presenter: IPresenter; const |

LoginParams: TLoginParams );

| | |
|---|---|
| 18: | destructor Destroy; override; |
| 19: | |
| 20: | class function CreateAction( Presenter: IPresenter; Params: |

Pointer ): IAction;

| | |
|---|---|
| 21: | |
| 22: | property ActionImpl: IActionImpl read FActionImpl write |

FActionImpl implements IAction;

| 23: | | |
|---|---|---|
| 24: | end; | |
| 25: | | |
| 26: | protected | |
| 27: | View: IView; | |
| 28: | | |
| 29: | FToolCloudsPane: | TExplorerPane; |
| 30: | | |
| 31: | FToolCloudMenu: | TPopupMenu; |
| 32: | FLoginInfoMenu: | TPopupMenu; |
| 33: | | |
| 34: | FToolCloudList: | TToolCloudList; |
| 35: | FToolCloudPresenter: | IPresenter; |
| 36: | | |
| 37: | FChargeToolboxPresenter: IPresenter; | |
| 38: | FLoginPresenter: | IPresenter; |
| 39: | | |
| 40: | FProductsController: | TProductsController; |

| | |
|---|---|
| 41: | |
| 42: | [...] |
| 43: | |
| 44: | public |
| 45: | constructor Create( AOwner: TComponent ); override; |
| 46: | destructor Destroy; override; |
| 47: | |
| 48: | procedure AfterConstruction; override; |
| 49: | |
| 50: | procedure LoadFromConfig; |
| 51: | procedure SaveToConfig; |
| 52: | |
| 53: | function connectToToolCloud( ToolCloud: |
| | TToolCloud ): Boolean; |

overload;

| | |
|---|---|
| 54: | |
| 55: | procedure connectToToolCloud( ToolCloudName: string ); |
| | overload; |
| 56: | |
| 57: | function disconnectFromToolCloud( ToolCloudName: string ): |

Boolean; overload;

| | |
|---|---|
| 58: | function disconnectFromToolCloud( ToolCloud: TToolCloud ): |

Boolean; overload;

| | |
|---|---|
| 59: | |
| 60: | function LoadToolCloudProducts( ToolCloud: TToolCloud; |
| | Products: |

TList<TProductItem> ): Boolean;

| | |
|---|---|
| 61: | |
| 62: | [...] |
| 63: | end; |

In particular, the workflow to retrieve toolcloud products is triggered by invoking the LoadToolCloudProducts method (line 60) of the TToolCloudsPresenter class, which is the class that handles all the aspects of working with toolcouds in the user's system. The LoadToolCloudProducts method may be implemented as follows:

```
  1: function TToolCloudsPresenter.LoadToolCloudProducts( ToolCloud:
TToolCloud;
  2: Products:
TList<TProductItem> ): Boolean;
  3: var
  4: product: TProductItem;
  5: begin
  6: Result := False;
  7:
  8: try
  9: if Assigned( ToolCloud ) and loginToToolCloud( ToolCLoud )
then
10: begin
11: Result := Assigned( ToolCloud ) and
12: FProductsController.GetProductList( ToolCloud,
13: Products );
14: //if no product is returned inform the user
15: if Result and (Products <> nil) and (Products.Count = 0) then
16: begin
17: MessageFrm( Application.MainForm, mfInfo,
Format(StrNoProductsAvailable, [User.LoginToken]) );
18: end;
19:
20: if Result then
21: begin
22: FProductsController.LoadProductsConfiguration( Products );
23:
24: // init defaults
25: for product in Products do
26: product.InitProductsDefaults;
27:
28: [...]
29: end;
30: [...]
31: end;
```

As shown, the method receives the toolcloud instance (ToolCloud) indicating which products should be loaded, together with the list in which the products must be filled in case of success. Internally after checking parameter validity and proper context (i.e., existence of a proper toolcloud connection), the method uses FProductController (see TProductsController below) to perform the WebService call and conversion between parameters format used by the Web Service format used in the ToolBox.

Thereafter, the system may proceed to retrieve privileges, as configured on the toolcloud for that (current) user, in order to update the ToolBox UI accordingly—that is, show/hide or enable/disable components and controls, as appropriate for the current user's privileges. Here, the above-mentioned ToolCloud.Login method calls the AdministrationProvider.getPrivileges function defined and implemented as above with a similar flow as the login User method described above. In particular, the getPrivileges WebService method receives a SessionID parameter and returns an array of strings that identify to which ToolBox functionalities the logged-in user has access to. The list of privileges is stored in the Privileges member of the TToolBoxUser instance which has been passed in to the ToolCloud.Login method. This is used by the ToolBox core to update the UI at the end of the connect-to-toolcloud workflow. After that ToolCloud connection has been established and the UI updated, the ToolBox attempts to load products to which the logged-in user has access and display them according to display product settings. The TProductsController class (including GetProductList class method) may be defined as follows:

```
  1: type TProductsController = class
  2: strict private
  3: FConfig: IPersistence;
  4:
  5: public
  6: constructor Create;
  7: destructor Destroy; override;
  8: function GetProductList( ToolCloud: TToolCloud;
  9: ProductList: TList<TProductItem> ):
Boolean;
10: function GetAllProducts( ToolCloud: TToolCloud;
11: ProductList: TList<TProductItem> ):
Boolean;
12:
13: procedure LoadProductsConfiguration( PProductList:
TList<TProductItem> );
14: procedure SaveProductsConfiguration( PProductList:
TList<TProductItem> );
15: class function GetInstalled( BuildFileItem: TProductBuildFile ) :
TProductBuildFile;
16: class procedure AddInstalledProducts( Result:
TList<TProductItem> );
17: class function HasInstalledBuildFile( PProductVersion:
TProductVersion): boolean; static;
18: end;
19:
20: function TProductsController.GetProductList( ToolCloud:
TToolCloud;
21: ProductList:
TList<TProductItem> ): Boolean;
22: begin
23: Result := TToolCloudConnection.getProducts( ToolCloud,
ProductList);
24: if Result then
25: AddInstalledProducts( ProductList );
26: end;
```

As shown (lines 20-26), a ToolCloudConnection instance invokes a GetProductList member function to establish a connection with a particular toolcloud (ToolCloud) and gets the list of products (ProductList). If the list is not empty (“if” statement at line 25 evaluates to True), that product list may be added to one's ToolBox.

The toolcloud connection, TToolCloudConnection, which may be implemented as follows:

```
  1: type TToolCloudConnection = class sealed
  2: public
  3: class function getLoginToken: string;
  4: class function getProducts( ToolCloud: TToolCloud;
  5: ProductList: TList<TProductItem>
): Boolean;
  6: class function getAllProducts( ToolCloud: TToolCloud;
ProductList: TList<TProductItem> ): Boolean;
  7: class function getProfiles( ToolCloud: TToolCloud;
  8: ProfileList: TList<TProfileItem>;
  9: ProductVersion :TProductVersion
): Boolean;
10:
11: class function GetUsageStatisticsProvider(
12: PURLforWSDL: string ):
IUsageStatisticsProvider;
13:
14: class function getAllAccessLicensesLocation(ToolCloud:
TToolCloud;
15: var LicenseLocations:
productWebService_v10.ArrayOfString): Boolean;
16:
17: class function getTrialLicenses( ToolCloud: TToolCloud;
18: Licenses:
TList<TTrialLicenseFile> ): Boolean;
19: end;
20:
21: class function TToolCloudConnection.getProducts( ToolCloud:
TToolCloud;
22: ProductList:
TList<TProductItem> ): Boolean;
23: var
24: pws: productWebService_v10PortType;
25: products: ArrayOfProduct;
26: login: string;
27: begin
28: Result := False;
29:
30: pws := GetproductWebService_v10PortType( True,
ToolCloud.getURLforWSDL );
31:
32: if pws <> nil then
33: begin
34: products := pws.getProducts( ToolCloud.SessionID );
35: ConvertProductTypes( products, ProductList );
36: Result := True;
37: end
38: else
39: TLog.GetInstance.Error( ‘productWebService_v10PortType is
nill’ );
40: end;
```

In particular at lines 21-40, the getProducts member function receives a particular ToolCloud instance for which products should be retrieved, together with the list to be filled (with those products). It returns a Boolean value indicating whether the call was successful.

Internally an instance of productWebService_v10 is created by invoking a GetproductWebService_v10PortType function; then, the getProducts method exposed by WebService is invoked passing in as a parameter the SessionID. The webService method returns an array of products in the WebService format. Therefore, a conversion is employed to translate this into a format used by ToolBox to represent products (ConvertProductTypes call). Next, TToolCloudConnection.getProdcuts returns the products controller which iterates over products. For each version checked, it adds entries for any installed applications found on the local machine. Thereafter, the Products Controller.getProducts method returns successfully. TToolCloudPresenter.LoadToolCloudProducts is invoked to check and load configurations for default version and builds, and returns True to report success to the caller.

(2) Launch a Product

The launch of a product can be invoked from several places in UI but in all the cases it is handled by an instance of the TProductPresenter class, which deals with all aspects of interacting with a product in the user's ToolBox. The TProductPresenter class may be defined as below (edited to focus on members relevant to launching a product):

```
  1: TProductPresenter = class( TPresenter, IPresenter )
  2:
  3: type
  4: IProductContext = interface
  5: function IsValid: Boolean;
  6: end;
  7:
  8: TToolCloudContext = class( TInterfacedObject,
IProductContext )
  9: protected
10: FPresenter: TProductPresenter;
11: FToolCloudName: string;
12:
13: function IsValid: Boolean;
14:
15: public
16: constructor Create( Presenter: TProductPresenter );
17:
18: end;
19:
20: TLocalLibraryContext = class( TInterfacedObject,
IProductContext )
21: protected
22: FPresenter: TProductPresenter;
23: FPackageName: string;
24:
25: function IsValid: Boolean;
26:
27: public
28: constructor Create( Presenter: TProductPresenter );
29:
30: end;
31:
32: TConfigureProduct = class( TInterfacedInstance, IAction )
33: protected
```

| | |
|---|---|
| 34: FActionImpl: | IActionImpl; |
| 35: FPresenter: | TProductPresenter; |
| 36: FProductName: | WideString; |
| 37: | |
| 38: FContext: | IProductContext; |

39:
40: function Configure: LRESULT;
41: procedure CaptureContext;
42:
43: public
44: constructor Create( Presenter: TProductPresenter;
ProductName: WideString );
45: destructor Destroy; override;
46:
47: class function CreateAction( Presenter: IPresenter; Params:
Pointer ): IAction;
48:
49: property ActionImpl: IActionImpl read FActionImpl write
FActionImpl implements IAction;
50: end;
51:
52: protected
53: [...]
54: procedure CMDLaunch( var Command: TCommand ); message
CMD_LAUNCH;
55: procedure CMDInstall( var Command: TCommand ); message
CMD_INSTALL;
56: procedure CMDUninstall( var Command: TCommand ); message
CMD_UNINSTALL;
57:
58: [...]
59: procedure Launch( Build: TProductBuildFile );
60: procedure Install( Build: TProductBuildFile );
61: procedure UnInstall( Build: TProductBuildFile );
62: procedure Download( Build: TProductBuildFile );
63: procedure CancelDownload( Build: TProductBuildFile );
64: procedure ResumeDownload( Build: TProductBuildFile );
65:
66: public
67: constructor Create( Owner: TComponent ); override;
68: destructor Destroy; override;
69:
70: [...]
71: end;

Of particular interest are the CMDLaunch and CMDInstall class methods, which serve respectively as front-ends to Launch and Install methods:

```
  1: procedure TProductPresenter.CMDLaunch( var Command:
TCommand );
  2: begin
  3: if TObject( Command.Params ) is TProductBuildFile then
  4: Launch( TProductBuildFile(Command.Params) );
  5: end;
  6:
  7: procedure TProductPresenter.CMDInstall( var Command:
TCommand );
  8: begin
  9: if TObject(Command.Params) is TProductBuildFile then
10: Install( TProductBuildFile(Command.Params) );
11: end;
12:
13: procedure TProductPresenter.Launch(Build: TProductBuildFile);
14: var
15: LProductItem: TProductItem;
16: LUser: TToolBoxUser;
17: LToolCloudList: TToolCLoudList;
18: begin
19: if Assigned( Build ) then
20: begin
```

| | |
|---|---|
| 21: LProductItem | := getProduct; |
| 22: LToolCloudList | := getToolCloudList; |
| 23: LUser | := getUser; |

24:
25: if Assigned(LProductItem) and
26: Assigned(LToolCloudList) and
27: Assigned(LUser) then
28: begin
29: with TLaunchAction.Create( LToolCloudList.ActiveToolCloud,
30: LUser.LoginToken,
31: Build ) do
32: Execute;
33: end;
34: end;
35: end;
36:
37: procedure TProductPresenter.Install(Build: TProductBuildFile);
38: var
39: newBf: TProductBuildFile;
40: BuildFiles: ArrayOfTProductBuildFile;
41: begin
42: if Assigned(Build) and Assigned(build.ProductVersion) then
43: begin
44: Launch( Build );
45:
46: newBf := TProductsController.GetInstalled( Build );
47:
48: if newBf <> nil then
49: begin
50: BuildFiles := Build.ProductVersion.BuildFiles;
51: SetLength ( BuildFiles, Length( BuildFiles ) + 1 );
52: BuildFiles[ Length( BuildFiles ) − 1] := newBf;
53:
54: Build.ProductVersion.BuildFiles := BuildFiles;
55:
56: // set the installed as default
57: Build.ProductVersion.setDefaultBuildFile( newBf );
58: end;
59: end;
60: end;

From the UI (and via Delphi® dynamic method invocation), the CMDLaunch method is invoked with build file pointer packed in its Command argument if the build to be launched as an instant-on or an installed application, and CMDInstall if the build is an installer application. In particular, the role of the CMDLaunch and CMDInstall methods is to unwrap the product build parameter and invoke the appropriate method Launch/Install methods that will, in turn, perform the required action.

The Launch method extracts the context for launch action and creates an instance of TLauchAction defined as follows:

```
  1: TLaunchAction = class
  2: FProductBuildFile: TProductBuildFile;
  3: FToolCloud: TToolCloud;
  4: FUser: string;
  5: public
  6: constructor Create( ToolCloud: TToolCloud;
  7: User: string;
  8: BuildFile : TProductBuildFile );
  9: procedure Execute;
10: end;
```

As shown, the LaunchAction method invokes an Execute method in order to actually launch the product. The Execute method also performs the following actions: Identify the place where the application should be launched (locally or network) based on the BuildFile passed in; Setup licenses for the given product to be launched; Identify the executable and the parameters required to run the product; Launch the .exe file and return if build is an instant-on, or block the ToolBox UI until the application exits if the build is an installer; and Handle errors (if any) and report them in a user friendly format using error message boxes.

(3) Charging Products Workflow

Program logic for charging the products wizard is contained in a TChargeToolboxPresenter class, which may be defined as follows:

```
  1: TChargeToolboxPresenter = class( TPresenter )
  2:
  3: type
  4: TGetSelectedSizeText = function( Product: TProductItem ):
WideString of object;
  5:
  6: TSelectedSizeAttribute = class( TAttribute )
  7: protected
  8: FGetter: TGetSelectedSizeText;
  9:
10: function getText: WideString; override;
11:
12: public
13: constructor Create( Product: TProductItem; AttributeName:
WideString; Getter: TGetSelectedSizeText );
14:
15: end;
16:
17: protected
```

| | |
|---|---|
| 18: FToolCloud: | TToolCloud; |
| 19: | |
| 20: FToolCloudProducts: | TObjectList<TProductItem>; |
| 21: FProductVersions: | TObjectList<TProductItem>; |
| 22: FSelectedProducts: | TObjectList<TProductItem>; |

23:
24: function getToolCloudList: TToolCloudList;
25: function getLocalLibraryPresenter: IPresenter;
26:
27: function getToolCloudProducts: TList<TProductItem>;
28: function getProductVersions: TList<TProductItem>;
29: function getSelectedProducts: TList<TProductItem>;
30:
31: function getToolCloudProduct( ProductName: WideString ):
TProductItem ;
32: function getSelectedProduct( ProductName: WideString; var
SelectedProduct: TProductItem ): Boolean;
33: function getProductSelectedItemsSize( Product: TProductItem ):
WideString;
34:
35: { IPresenter }
36: procedure InitView( View: IView ); override;
37:
38: // commands
39: procedure CMDSetToolCloud( var Command: TCommand ); message
CMD_SETTOOLCLOUD;
40: procedure CMDLoadProducts( var Command: TCommand ); message
CMD_LOADPRODUCTS;
41: procedure CMDSelectProduct( var Command: TCommand ); message
CMD_SELECTPRODUCT;
42: procedure CMDSelectProductVersion( var Command: TCommand );
message CMD_SELECTPRODUCTVERSION;
43: procedure CMDChargeToolBox( var Command: TCommand ); message
CMD_CHARGETOOLBOX;
44: procedure CMDLoadProductVersions( var Command: TCommand );
message CMD_LOADPRODUCTVERSIONS;
45: procedure CMDCheckFilter(var Command: TCommand); message
CMD_CHECKFILTER;
46: procedure CMDFilterSelect(var Command: TCommand); message
CMD_FILTERSELECT;
47: procedure CMDFilterUnselect(var Command: TCommand); message
CMD_FILTERUNSELECT;
48:
49: // message handlers
50: procedure MSGToolCloudListChanged( var Message: TMessage );
message MSG_TOOLCLOUDLISTCHANGED;
51: procedure MSGDownloadFinished( var Message: TMessage ); message
MSG_DOWNLOADFINISHED;
52:
53: procedure ChargeProducts( Products: TList<TProductItem>;
ChargeOptions: TChargeOptions );
54: procedure ChargeAllProducts( ChargeOptions: TChargeOptions );
55: procedure ChargeSelectedProducts;
56:
57: procedure SelectProduct( Product: TProductItem; ChargeOptions:
TChargeOptions; SelectedBuilds: TStringList = nil );
58: procedure UnselectProduct( Product: TProductItem );
59:
60: function ChargeBuild( Build: TProductBuildFile;
61: ChargeOptions: TChargeOptions): boolean;
62:
63: procedure SelectVersion(ASelectedProduct: TProductItem; AVersion:
TProductVersion; BuildTypes: TChargeOptions);
64:
65: public
66: constructor Create( Owner: TComponent ); override;
67: destructor Destroy; override;
68:
69: published

| | |
|---|---|
| 70: property ToolCloud: | TToolCloud read FToolCloud; |
| 71: property ToolCloudList: | TToolCloudList read getToolCloudList; |
| 72: | |
| 73: property Products: | TList<TProductItem> read getToolCloudProducts; |
| 74: property Versions: | TList<TProductItem> read getProductVersions; |
| 75: property Selection: | TList<TProductItem> read getSelectedProducts; |

76:
77: property LocalLibraryPresenter: IPresenter read
getLocalLibraryPresenter;
78: end;

Of particular interest are the toolcloud from which products are charged and the list of products to be charged (defined by user when using actions performed in wizard.)

The method that is invoked by the UI to start charging is CMDChargeToolBox, which gets invoked (through Delphi® dynamic method invocation mechanism) when a Charge link in pressed in any wizard page. The method may be defined as follows:

| 1: procedure TChargeToolboxPresenter.CMDChargeToolBox(var | |
|---|---|
| Command: TCommand); | |
| 2: | |
| 3: function ChargingBuilds: Boolean; | |
| 4: var | |
| 5: product: | TProductItem; |
| 6: version: | TProductVersion; |
| 7: build: | TProductBuildFile; |

```
  8: begin
  9: Result := False;
10:
11: for product in FSelectedProducts do
12: for version in product.getVersions do
13: for build in version.BuildFiles do
14: if build.IsDownloadInProgress then
15: begin
16: result := True;
17: break;
18: end;
19: end;
20:
21: var
22: chargeOptions: TChargeOptions;
23: begin
24: chargeoptions := PChargeOptions(Command.Params)\hat{ };
25:
26: if AllProducts in chargeOptions then ChargeAllProducts(
ChargeOptions );
27: if SelectedProducts in chargeOptions then
ChargeSelectedProducts( );
28:
29: // check if there is any build in download for selected products
and display download view
30: if ChargingBuilds then
31: TToolCloudsPresenter(Owner).ApplicationPresenter.Execute(
CMD_CHANGETOOLVIEW, Pointer(DownloadsViewID) )
32: else
33: // display toolcloud product list
34: LocalLibraryPresenter.Execute( ACT_SELECTPACKAGE,
PWideChar(SAllAccessPackage) );
35: end;
```

As shown, the method receives (within the TCommand argument) a pointer to TChargeOptions enum (enumerated) set, which is implemented as follows:

1: TChargeOption = (AllProducts, SelectedProducts, LatestVersions,
AllBuilds, InstantONs, Installers);
2: TChargeOptions = set of TChargeOption;
3: PChargeOptions = \hat{ }TChargeOptions;

As shown, this allows specification of AllProducts or SelectedProducts, as well as Latest Versions, AllBuilds, InstantONs, and Installers.

If AllProducts is specified then ChargeAllProducts is called; otherwise, if SelectedProducts is specified the ChargeSelectedProducts method is called. Both these functions in turn call the ChargeProducts method, with the difference being the list of products to be charged. The ChargeAllProducts method may be implemented as follows.

```
  1: procedure TChargeToolboxPresenter.ChargeAllProducts(
ChargeOptions: TChargeOptions );
  2:
  3: begin
  4: // make sure download icons thread is stopped
  5: IconCache.Instance.ProductIcons.CancelDownload;
  6:
  7: // load toolcloud products
  8: FSelectedProducts.Clear;
  9: if TToolCloudsPresenter(Owner).LoadToolCloudProducts(
FToolCloud, FSelectedProducts ) then
10: begin
11: ChargeProducts( FSelectedProducts, ChargeOptions );
12: end;
13: end;
14:
15: procedure TChargeToolboxPresenter.ChargeSelectedProducts;
16: begin
17: ChargeProducts( FSelectedProducts, [AllBuilds] );
18: end;
```

ChargeAllProducts loads all the products available to the logged-in user and passes this list to ChargeProducts along with Charge Options parameter received. The ChargeSelectedProducts method passes ChargeProducts the list of products as selected by the user using the last two wizard pages and the AllBuilds option (as the product filtering has been already performed).

The ChargeProducts method may be implemented as follows:

| 1: procedure TChargeToolboxPresenter.ChargeProducts( Products: | |
|---|---|
| TList<TProductItem>; | |
| 2: ChargeOptions: | |
| TChargeOptions ); | |
| 3: var | |
| 4: product: | TProductItem; |
| 5: version: | TProductVersion; |
| 6: build: | TProductBuildFile; |
| 7: | |
| 8: builds: | TList<TProductBuildFile>; |
| 9: params: | TAddBuildsToPackage; |

10: begin
11: builds := TList<TProductBuildFile>.Create;
12: params := TAddBuildsToPackage.Create( builds, nil );
13:
14: try
15: for product in Products do
16: for version in product.getVersions do
17: for build in version.BuildFiles do
18: begin
19: if ChargeBuild( build, ChargeOptions ) then
20: builds.Add( build );
21: end;
22:
23: LocalLibraryPresenter.Execute(
CMD_ADDPRODUCTTOPACKAGE, params );
24:
25: finally
26: params.Free;
27: builds.Free;
28: end;
29: end;

As shown, the ChargeProducts method creates an instance of TAddBuildsToPackage class and fills it with the builds to be charged, according to the option passed in ChargeOptions parameter (which must specify the type of builds to include). With this structure filled in, the CMD_ADDPRODUCTTOPACKAGE command is invoked on LocalLibraryPresenter to perform the actual charge operation (i.e., adding an entry in the local library and starting to download products from download locations). After all these function return, the CMDChargeProdcuts method checks to see if at least one download has been started and, if so, switches the view to “Downloads view” in order to track download progress. In the case that no download has started (i.e. none of the selected products are cached on the toolcloud), the ToolBox returns to its previous view (i.e., the list of products for the active toolcloud).

(4) Setup Product Licenses Logic

The logic for setting up licenses required to run an application from the ToolBox is encapsulated in a SetupLicenses function:

function SetupLicense(aProductBuildFile: TProductBuildFile; ToolCloud:
TToolCloud ): Boolean;

As shown, the function receives two parameters—a build file instance (aProductBuildFile) and an active toolcloud instance (ToolCloud)—and returns a Boolean to report success or failure. The build file instance contains a member that lists all locations on the local system where a license file must be present in order to run the respective application. This information is received with the other product details and metadata, when products are loaded from ToolCloud after a connection is established. These locations are in a canonical format in order to be compatible with various systems and setups, such as “appdata\Embarcadero” (which refers to Embarcadero Technologies' Application Data system directory).

For each entry in this list of locations, a call is made through WebServices in order to obtain (according to the previously configured access level) the licenses file to be copied locally. The call is performed using the previously described TToolCloudConnection class, by invoking a getAllAccessLicensesLocation method:

```
  1: // class method
TToolCloudConnection.getAllAccessLicensesLocation(ToolCloud:
TToolCloud;
  2: var LicenseLocations:
productWebService_v10.ArrayOfString): Boolean;
  3: var
  4: pws: productWebService_v10PortType;
  5: login: string;
  6: begin
  7: Result := false;
  8: pws := GetproductWebService_v10PortType( True,
ToolCloud.getURLforWSDL );
  9:
10: if pws <> nil then
11: begin
12: LicenseLocations :=
pws.getAllAccessLicensesLocation(ToolCloud.SessionID);
13: Result := True;
14: end
15: else
16: TLog.GetInstance.Error( ‘productWebService_v10PortType
is nill’ );
17: end;
```

The method creates internally an instance of productWebService_v10 and calls the getAllAccessLicensesLocation with the toolcloud SessionID as a parameter. The licenses locations obtained in return are in fact URLs within the toolcloud from which the ToolBox will download the license files to the local locations specified (above).

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. In a computer system, a method for automating delivery, licensing, and availability of application software, the method comprising:
storing at a host server a collection of software applications, together with metadata characterizing licensing and operation of the software applications;
providing a client user interface at a client device that allows a user to select software applications from the host server;
in response to a request from the user for access to a particular software application from the host server, delivering the particular software application from the host server to a local library available to the client device together with the metadata describing licensing and operation of the particular application, said client user interface displaying information indicating to the user that the particular software application is now available for operation at the client device;
in response to a request from the user to operate the particular software application at the client device, determining whether the request complies with said licensing of the particular software application; and
if the request from the user to operate the particular software application complies with said licensing of the particular application, launching operation of the particular software application at the client device pursuant to said metadata.

2. The method of claim 1, wherein said host server comprises a public cloud server accessible to the client device via a public network.

3. The method of claim 1, wherein said host server comprises a private cloud server accessible to the client device via a private network.

4. The method of claim 1, wherein said software applications can be operated at the client device without installation.

5. The method of claim 1, wherein said software applications can be optionally installed at the client device before operation.

6. The method of claim 1, further comprising:
virtualizing at least a portion of the particular software application's operation, to limit the particular software application's impact on the client device.

7. The method of claim 6, wherein at least a portion of the particular software application's file operations are virtualized.

8. The method of claim 6, wherein at least a portion of the particular software application's registry operations are virtualized.

9. The method of claim 1, wherein said step of providing a client user interface includes:
displaying a dashboard interface indicating a local library having software applications available and licensed for operation at the client device.

10. The method of claim 9, wherein said dashboard interface further indicates a public marketplace having software applications available for licensing and operation at the client device, upon purchase.

11. The method of claim 1, wherein the particular software application delivered from the host server to the client device is packaged in a downloadable file.

12. The method of claim 11, wherein the particular software application is automatically unpacked from the downloadable file before it is operated at the client device.

13. The method of claim 11, wherein the particular software application packaged in the downloadable file is associated with a license slip file, indicating licensing rights for using the particular software application.

14. The method of claim 13, wherein said step of determining whether the request complies with said licensing of the particular software application includes:
examining the license slip file for determining licensing rights available for operating the particular software application at the client device.

15. The method of claim 11, wherein the particular software application is automatically unpacked from the downloadable file and operated at the client device, without installing the particular software application at the client device.

16. A system for delivering and licensing application software, the system comprising:
a cloud server storing a plurality of software applications, including storing metadata indicating permitted licensing and operation of the software applications;
a client computer for operating software applications, the client computer in communication with the cloud server;
a client user interface at the client computer, which allows a user to request software applications from the cloud server;
a communication module at the cloud server, for receiving requests from the user to operate particular software applications at the client computer;
an authentication module at the cloud server, for authenticating said requests received from the user to operate certain software applications at the client computer; and
a local library at the client computer for receiving from the cloud server the particular software applications requested by the user and making those applications available for operation at the client computer, pursuant to permitted licensing and operation specified by said metadata.

17. The system of claim 16, wherein said cloud server comprises a public cloud server accessible to the client computer via a public network.

18. The system of claim 16, wherein said cloud server comprises a private cloud server accessible to the client computer via a private network.

19. The system of claim 16, wherein said software applications can be operated at the client computer without installation.

20. The system of claim 16, wherein said software applications can optionally be installed at the client computer before operation.

21. The system of claim 16, further comprising:
a module for virtualizing at least a portion of the particular software applications' operation, to limit effect on the client computer.

22. The system of claim 21, wherein at least a portion of the particular software applications' file operations are virtualized.

23. The system of claim 21, wherein at least a portion of the particular software applications' registry operations are virtualized.

24. The system of claim 16, wherein said client user interface comprises a dashboard interface indicating software applications available and licensed for operation at the client computer.

25. The system of claim 24, wherein said dashboard interface further indicates a public marketplace having software applications available for licensing and operation at the client computer, upon purchase.

26. The system of claim 16, wherein each particular software application delivered from the cloud server to the client computer is packaged in a downloadable file.

27. The system of claim 26, wherein each particular software application is automatically unpacked from its respective downloadable file before being operated at the client computer.

28. The system of claim 26, wherein each particular software application packaged in a downloadable file is associated with a license slip file, indicating licensing rights for using that particular software application.

29. The system of claim 28, wherein said license slip file is consulted for determining licensing rights available for operating that particular software application at the client computer.

30. The system of claim 26, wherein at least some of the particular software applications are automatically unpacked from respective downloadable files and immediately operated at the client computer without prior installation at the client computer.
